(19) United States
(12) Patent Application Publication
(10) Pub. No.: US 2009/0145249 A1
(43) Pub. Date: Jun. 11, 2009

(54) MODULAR SCANNER ASSEMBLY

(76) Inventors: Arthur J. DUBBELDAM, Ardrossan (CA); Mark P. DUBBELDAM, Ardrossan (CA); Paul E. TORSTENSEN, Ardrossan (CA); Jason P. WIEBE, Edmonton (CA)

Correspondence Address: DAVIS & BUJOLD, P.L.L.C., 112 PLEASANT STREET, CONCORD, NH, 03301, US

(21) Appl. No.: 11/875,511

(22) Filed: Oct. 19, 2007

Related U.S. Application Data
(60) Provisional application No. 60/853,217, filed on Oct. 20, 2006.

(51) Int. Cl. G01D 21/00

(52) U.S. Cl. 73/866.5

(57) ABSTRACT

A modular scanner assembly includes a probe holder support constructed from interconnected reconfigurable members. At least one of the interconnected reconfigurable members has a probe holder. The probe holder support has wheels attached to at least one interconnected reconfigurable member for moving the probe holder support across a surface to be scanned. At least one of the wheels is connected to a position encoder.

### FIELD

The present invention relates to a modular scanner assembly.

### BACKGROUND

There are many situations where defects in materials and/or the welds of the materials must be detected to ensure quality control. The defects may be internal flaws such as cracks, voids, etc. produced during the manufacturing of the material, flaws in the area of a weld due to inadequate welding preparation and/or practice, or surface irregularities due to, in most cases, corrosion.

A preferred method for detecting these flaws is called non-destructive testing, or inspection. In non-destructive testing, flaws are detected by various types of sensors, or probes, which are translated over the material's surface in a controlled manner, collecting data along the way.

### SUMMARY

There is provided a modular scanner assembly. The modular scanner assembly comprises a probe holder support constructed from interconnected reconfigurable members. At least one of the interconnected reconfigurable members has a probe holder. There is at least one communicator for carrying signals from a probe held by the probe holder. The probe holder support has wheels attached to at least one interconnected reconfigurable member for moving the probe holder support across a surface to be scanned.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1A is an end elevation view of a bar assembly.

FIG. 1B is a side elevation view in section of the bar assembly along the line A-A shown in FIG. 1B.

FIG. 2A is a perspective view of a connector block and removable knob assembly.

FIG. 2B is a side elevation view of the connector block and removable knob assembly.

FIG. 2C is a rear elevation view in section of the connector block and removable know assembly along the line A-A shown in FIG. 2B.

FIG. 3A is a perspective view of a cross block assembly.

FIG. 3B is a front elevation view of the cross block assembly.

FIG. 3C is a side elevation view in section of the cross block assembly along the line A-A shown in FIG. 3B.

FIG. 4A is a perspective view of a pivot assembly.

FIG. 4B is a front elevation view of the pivot assembly.

FIG. 4C is a side elevation view in section of the pivot assembly along the line A-A shown in FIG. 4B.

FIG. 4D is a side elevation view in section of the pivot assembly along the line B-B shown in FIG. 4B.

FIG. 4E is a bottom plan view of the pivot assembly.

FIG. 5A is a perspective view of a first end of a swivel assembly.

FIG. 5B is a perspective view of a second end of the swivel assembly.

FIG. 5C is a top plan view of the swivel assembly.

FIG. 5D is an end elevation view of the swivel assembly.

FIG. 5E is a side elevation view of the swivel assembly.

FIG. 5F is a diagonal view in section of the swivel assembly along the line B-B shown in FIG. 5D.

FIG. 5G is a side elevation view in section of the swivel assembly along the line A-A shown in FIG. 5C.

FIG. 6A is a perspective view of a wheel block assembly.

FIG. 6B is a top plan view of the wheel block assembly.

FIG. 6C is a side elevation view of the wheel block assembly.

FIG. 6D is a top plan view in section of the wheel block assembly along the line B-B shown in FIG. 6C.

FIG. 7A is a perspective view of an encoded wheel block assembly.

FIG. 7B is a top plan view of the encoded wheel block assembly.

FIG. 7C is a side elevation view of the encoded wheel block assembly.

FIG. 7D is a top plan view in section of the encoded wheel block assembly along the line B-B shown in FIG. 7C.

FIG. 8A is a perspective view of a probe holder assembly.

FIG. 8B is a top plan view of the probe holder assembly.

FIG. 8C is an end elevation view of the probe holder assembly pivoting about a first pivot axis.

FIG. 8D is a side elevation view of the probe holder assembly.

FIG. 8E is a side elevation view of the probe holder assembly pivoting about a second pivot axis.

FIG. 8F is a side elevation view of the probe holder assembly pivoting about a third pivot axis.

FIG. 8G is bottom plan view in section of the probe holder assembly along the line B-B shown in FIG. 8D.

FIG. 9A is a perspective view of a probe clamp assembly.

FIG. 9B is a first side elevation view of the probe clamp assembly.

FIG. 9C is a second side elevation view of the probe clamp assembly.

FIG. 9D is a top plan view of the probe clamp assembly.

FIG. 9E is an end elevation view in section of the probe clamp assembly along the line A-A shown in FIG. 9D.

FIG. 9F is a bottom plan view of the probe clamp assembly.

FIG. 9G is an end elevation view in section of a portion of the probe clamp assembly along the line C-C shown in FIG. 9F.

FIG. 10A is a perspective view of the front end of a probe pivot assembly.

FIG. 10B is a perspective view of the rear end of the probe pivot assembly.

FIG. 10C is a front elevation view of the probe pivot assembly.

FIG. 10D is a side elevation view in section of the probe pivot assembly along the line A-A shown in FIG. 10C.

FIG. 10E is a top plan view of the probe pivot assembly.

FIG. 10F is a side elevation view in section of a spring strut of the probe pivot assembly along the line B-B shown in FIG. 10E.

FIG. 10G is a side elevation view of the probe pivot assembly.

FIG. 11A is a perspective view of a wheel base assembly with the cover removed.

FIG. 11B is a side elevation view of the wheel base assembly.

FIG. 11C is a bottom plan view in section of the wheel base assembly along the line B-B shown in FIG. 11B.

FIG. 11D is a detailed bottom plan view of an axle/wheel assembly of the wheel base assembly.

FIG. 12A is a perspective view of an umbilical assembly.

FIG. 12B is an end elevation view of the umbilical assembly.

FIG. 12C is a side elevation view of the umbilical assembly.

FIG. 12D is an end elevation view of the umbilical assembly with a handle installed.

FIG. 12E is a side elevation view in section of the umbilical assembly with the handle installed along the lines D-D shown in FIG. 12D.

FIG. 13A is a perspective view of an arm assembly.

FIG. 13B is a side elevation view of the arm assembly.

FIG. 13C is a top plan view in section of the arm assembly along the line B-B shown in FIG. 13B.

FIG. 14A is a perspective view of a swing arm probe holder.

FIG. 14B is a top plan view of the swing arm probe holder.

FIG. 14C is a side elevation view in section of the swing arm probe holder along the line A-A shown in FIG. 14B.

FIG. 14D is a side elevation view in section of the swing arm probe holder along the line B-B shown in FIG. 14B.

FIG. 14E is a side elevation view in section of the swing ann probe holder along the line C-C shown in FIG. 14B.

FIG. 14F is a front elevation view of the swing arm probe holder pivoting about the first axis.

FIG. 14G is a top plan view of the swing arm probe holder with an alternative probe holding means.

FIG. 15A is a perspective view of a virtual pivot probe holder.

FIG. 15B is a top plan view of the virtual pivot probe holder.

FIG. 15C is a side elevation view of the virtual pivot probe holder.

FIG. 15D is a bottom plan view of the virtual pivot probe holder viewed along the line C-C shown in FIG. 15C.

FIG. 15E is a front elevation view in section of the virtual pivot probe holder along the line B-B shown in FIG. 15C.

FIG. 16A is a perspective view of a lateral probe positioner assembly mounted on a bar.

FIG. 16B is a top plan view of the lateral probe positioner assembly.

FIG. 16C is a bottom plan view of the lateral probe positioner assembly mounted on the bar.

FIG. 16D is a side elevation view in section of the lateral probe positioner assembly along the line A-A shown in FIG. 16C.

FIG. 16E is an end elevation view in section of the lateral probe positioner assembly along the line B-B shown in FIG. 16C.

FIG. 16F is an end elevation view in section of the lateral probe positioner assembly along the line C-C shown in FIG. 16C.

FIG. 16G is a perspective view of a slide assembly of the lateral probe positioner assembly.

FIG. 17A is a top plan view of a sectional frame assembly.

FIG. 17B is a detailed end elevation view in section of a wheel block assembly of the sectional frame assembly along the line A-A shown in FIG. 17A.

FIG. 17C is a detailed end elevation view in section of a side member/bar connection of the sectional frame assembly along the line B-B shown in FIG. 17A.

FIG. 17D is a perspective view of the sectional frame assembly with the side members positioned on each end of the bars.

FIG. 17E is a perspective view of the sectional frame assembly with the side members positioned closer together.

FIG. 17F is side elevation view of the sectional frame assembly curved to match the curve of a surface.

FIG. 18A is a side elevation view of a chain scanner.

FIG. 18B is a perspective view of the chain scanner.

FIG. 18C is a detailed view in section of a buckle assembly used to clamp the chain scanner onto a surface.

FIG. 19A is a perspective view of an example of a simplified scanner assembly.

FIG. 19B is a top plan view of the example of a simplified scanner assembly.

FIG. 19C is a front elevation view of the example of a simplified scanner assembly.

FIG. 19D is a side elevation view of the example of a simplified scanner assembly.

FIG. 20 is a perspective view of an example of a more complex scanner assembly.

FIG. 21 is a perspective view of a scanner assembly constructed using the sectional frame assembly.

FIG. 22 is an example of a scanner assembly structured using the chain scanner.

### DETAILED DESCRIPTION

A modular scanner assembly may be made up of different interconnected reconfigurable members to form a probe holder support. The interconnected reconfigurable members described below, also referred to as modules or assemblies, include: a bar assembly, a removable knob assembly, a connector block assembly, a cross block assembly, a pivot assembly, a swivel assembly, a wheel block assembly, a wheel assembly, an encoded wheel block assembly, a probe holder assembly, a probe clamp assembly, a probe pivot assembly, a swing arm probe holder, a virtual pivot probe holder, a wheel base assembly, an umbilical assembly, an ergonomic handle, an arm assembly, a lateral probe positioner assembly, a sectional frame assembly, and a chain scanner assembly.

The assemblies described below may in turn be made up of interconnected reconfigurable members. It will be understood that the description below are some examples of members that may be used to form a probe holder support, and that other assemblies may be provided than those described herein, or the assemblies described may be modified, depending on the desired use.

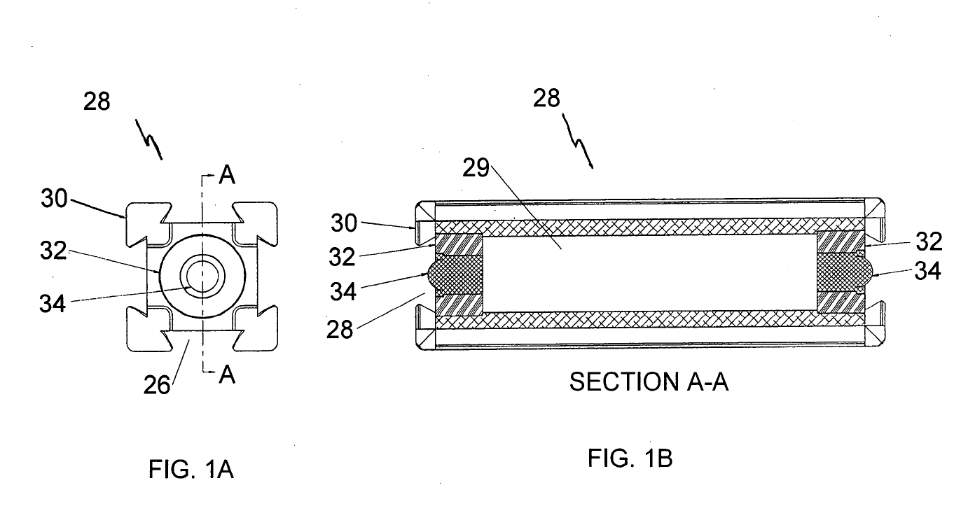

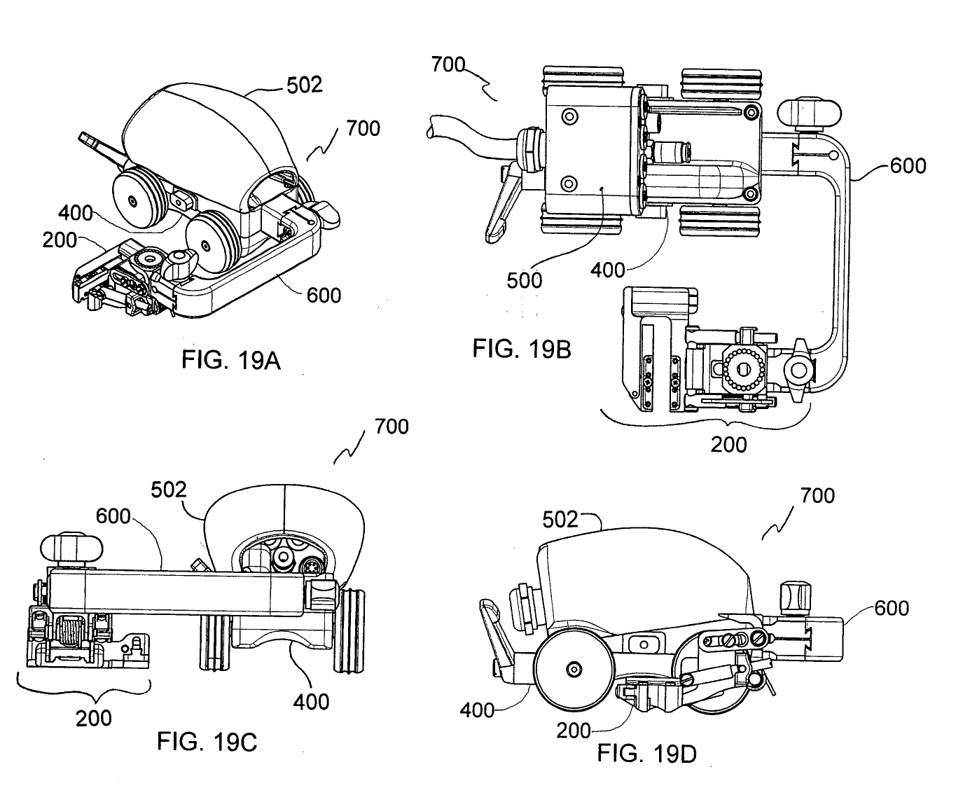

A description of the various interconnected reconfigurable members, or assemblies, that may be used to construct a scanner assembly will be given with reference to FIGS. 1 through 18C. Examples of scanner assemblies that may be constructed using these assemblies will then be given with reference to FIGS. 19A through 22.

The Bar Assembly

Referring to FIG. 1A, a bar assembly, generally identified by reference numeral 28 includes a bar 30 of square cross section with a dovetail groove 26 down each of the four sides. Referring to FIG. 1B, a pair of perpendicular dovetail grooves 28 are also in both ends of the bar 30, thus totaling 8 dovetail grooves on the bar 30. The dovetail grooves 26 and 28 are arranged in this manner such that a male dovetail part from a different module can be attached either horizontally or vertically in either end of the bar 30, as well as anywhere down its length, on any side.

A bushing 32 adapts the large through hole 29 in bar 30 to the spring loaded ball plunger 34. The through hole in bar 30 is for weight reduction. The ball plunger 34 and bushing 32 are typical in both ends of the bar 30. The purpose of the ball plunger 34 is to align any mating male dovetail part with the bar 30 prior to clamping the male dovetail part in place. While not shown, the male dovetail part would have an appropriate detent for the ball plunger 34 to register in.

To increase the flexibility of any given system, various lengths of bar assemblies may be provided.

The Removable Knob Assembly

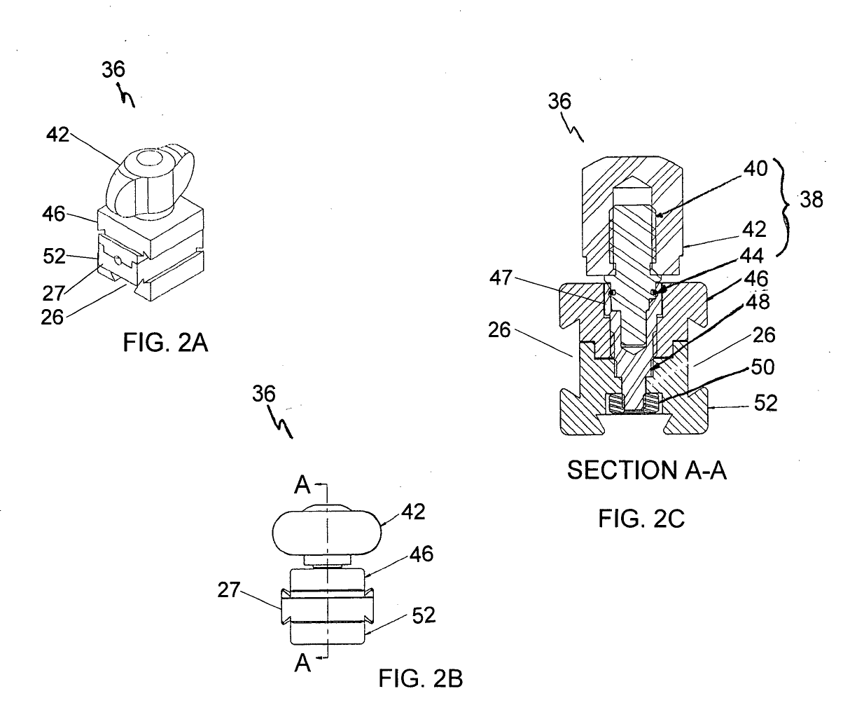

Referring to FIG. 2C, a removable knob assembly, generally indicated by reference numeral 38, is shown. As will be seen below, the removable knob assembly 38 is used in many of the interlocking components to tighten and loosen them. Situations may arise where two or more knobs interfere with each other, thus restricting the overall usability of the system. Finger knob 42, shaft 40, and spring clip 44 make up a removable knob assembly which is removed by hand simply by pulling it out of the mating socket 48. The finger knob 42 is permanently assembled by means of adhesive to the shaft 40. The shaft 40 contains a series of drive lobes, or spline 47, that engage with the socket 48 to transmit torque from the finger knob to the socket. A spring clip 44 retains the knob assembly 38 in the socket 48. The removable knob assembly 38 and socket 48 are used in a number of assemblies throughout the invention.

The Connector Block Assembly

Referring to FIGS. 2A through 2C, the connector block assembly is identified generally by reference numeral 36. The connector block assembly 36 is a component used for rigidly connecting two components together that have dovetail grooves. It is designed such that when used to connect to two bar assemblies 28 together in line (end to end), three of the four sides of the resultant assembly form continuous dovetail grooves. The fourth side is obstructed by the socket 48 of the connector block assembly 36.

Specifically, referring to FIG. 2C, the connector block assembly 36 has of a removable knob assembly 38, a socket 48, a nut 50, an upper block 46, and a lower block 52. The upper block 46 and lower block 52 together form a square cross section with 3 of the 4 sides containing dovetail grooves 26, the fourth side reserved for the socket 48 and the removable knob assembly 38. Referring to FIG. 2B, the upper block 46 and lower block 52 together also form a male dovetail 27 on both ends of the connector block assembly 36. Referring to FIG. 2C, when the removable knob assembly 38 is rotated in a clockwise direction, the socket 48 is threaded into the upper block 46 thus causing the small shoulder on socket 48 to push on the lower block 52. Referring to FIG. 2B, the resulting separating force between the upper block 46 and lower block 52 allows the connector block assembly 36 to be used to connect two components containing dovetail grooves together by means of the male dovetails 27 on each end of the connector block assembly 36 expanding within the dovetail grooves of the mating components. By rotating the removable knob assembly 38 in a counterclockwise direction, the socket 48 is threaded out of the upper block 46, thus causing the nut 50 to pull the lower block 52 along with the socket 48. This action contracts the male dovetails 27 within the mating parts' dovetail grooves, thus allowing disassembly of the mated components.

The Cross Block Assembly

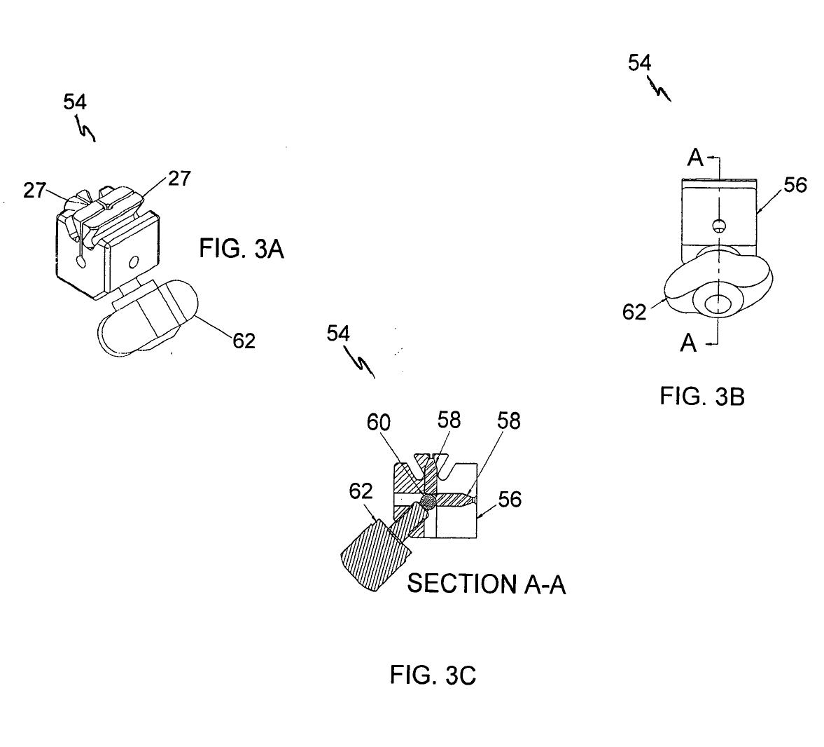

Referring to FIGS. 3A through 3C, the cross block assembly, generally identified by reference numeral 54, is used for connecting two components with dovetail grooves that are perpendicular to each other. It is designed so that both components are clamped with a single knob.

Referring to FIG. 3C, the cross block assembly 54 consists of a cross block 56, two tapered plungers 58, a ball 60, and a studded knob 62. Referring to FIG. 3A, the cross block 56 has two male dovetails 27 on adjacent faces that are perpendicular to each other. Each male dovetail 27 is slit to allow the dovetail 27 to flex. Referring again to FIG. 3C, the two tapered plungers 58 fit into tapered holes in the cross block 56. The ball 60 is positioned in the middle of the cross block 56 such that it contacts both of the tapered plungers 58. The studded knob 62 is threaded into a hole of the cross block 56, the axis of which bisects the included angle created by the axis of the two tapered plungers 58. When the studded knob 62 is rotated in a clockwise direction it contacts the ball 60, which in turn contacts both of the tapered plungers 58. The tapered portion of each tapered plunger 58 subsequently applies a force on the inner faces of the male dovetails 27 shown in FIG. 3A, thus creating a spreading action which expands the male dovetails 27 within the female dovetails of the mating components. When the studded knob 62 is rotated in a counterclockwise direction, the elasticity of the cross block 56 causes the male dovetails 27 to contract to their natural position, which subsequently forces the tapered plungers 58 and the ball 60 back into the cross block 56. The contraction of the male dovetails 27 allows disassembly of the mated components.

The Pivot Assembly

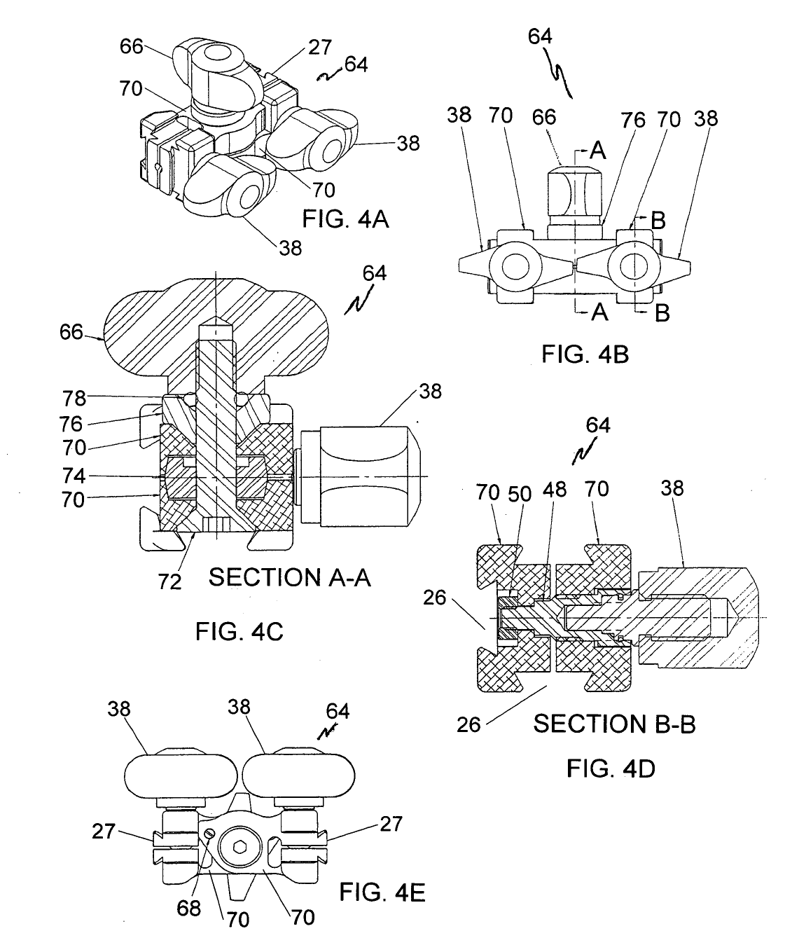

Referring to FIGS. 4A through 4E, the pivot assembly generally identified by reference numeral 64 is used to connect two components together that have dovetail grooves and allows, with the loosing of a finger nut 66, one rotational degree of freedom. Upon tightening the finger nut 66, the resultant assembly is rigid. If it were used to connect two bar assemblies 28 in line (end to end), the rotational degree of freedom would allow the central axis of the bar assemblies to be disposed either directly collinear or at an angle to each other.

Referring to FIG. 4C, the pivot assembly 64 consists of two pivot blocks 70 arranged horizontally opposed such that their axes of rotation align. This allows the assembly of a bolt 72, tapered disk 74, tapered washer 76, o-ring 78, and finger nut 66. By tightening the finger nut 66, the tapered faces of the two pivot blocks 70 align and mate with the tapered faces of the tapered disk 74, thus rigidly locking the components together. The tapered washer 76 acts as a spacer which transfers the compressive force from the finger nut 66 to the pivot block 70. An o-ring 78 prevents the finger nut 66 from freely spinning off of bolt 72 when the pivot assembly 64 is in the loosened state. Referring to FIG. 4E, a ball plunger 68 pushes from the near pivot block 70 into a series of detents (not shown) in the opposing pivot block 70 so as to generate some tactile feedback every 10 degrees of rotation of the near pivot block 70 with respect to the opposing pivot block 70. A second ball plunger (not shown) operates in the exact same manner from the opposing pivot block to the near pivot block 70. This provides a means of repeatable positioning of the pivot assembly 64.

Referring to FIG. 4A, the outer end of each pivot block 70 contains a male dovetail 27 clamping system involving, referring to FIG. 4D, a removable knob assembly 38, socket 48, and nut 50. The operation is similar to that described for the connector block assembly 36 above, except rather than two separate components being expanded and retracted (upper block 46 and lower block 52), pivot block 70 is split to allow enough flexibility for the expansion and retraction of the male dovetail.

The Swivel Assembly

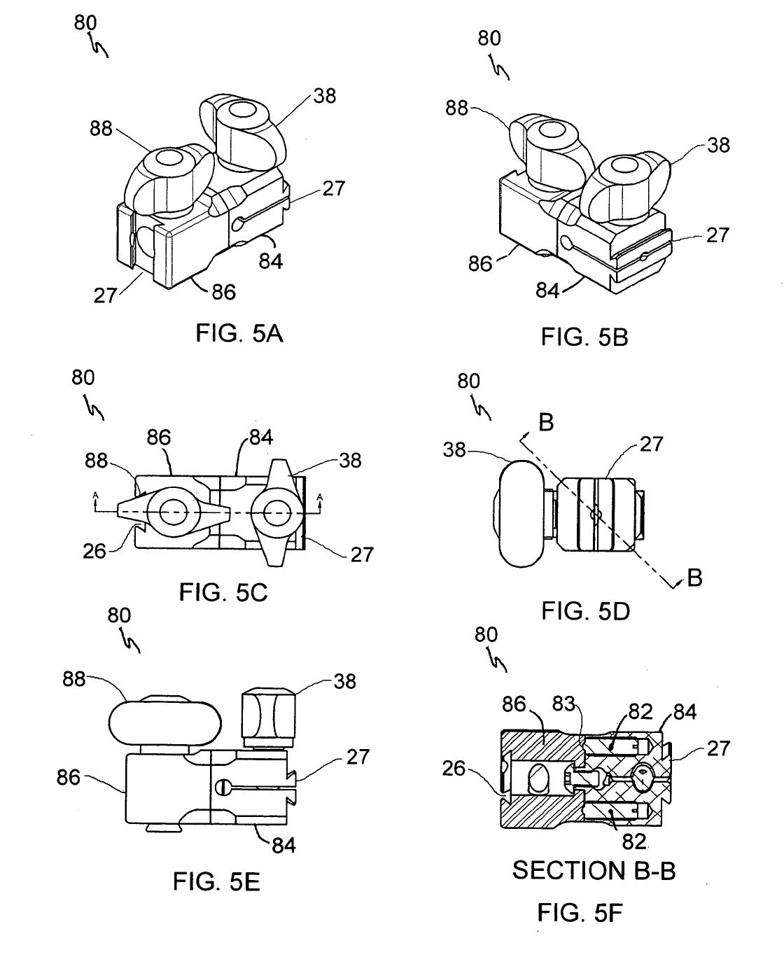

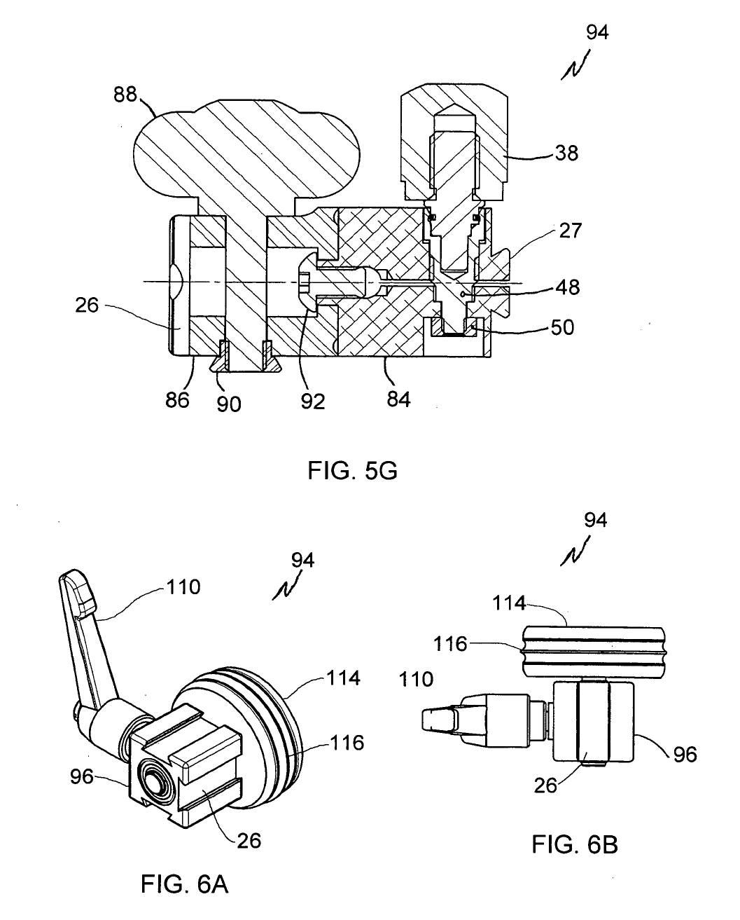

Referring to FIGS. 5A through 5G, the swivel assembly, identified generally by reference numeral 80, is a component used for connecting two components together that have dovetail grooves and that allows one rotational degree of freedom. The rotational degree of freedom is held in one of a number of positions by means of a plurality of ball plungers 82, disposed about the axis of rotation and contained in the swivel block 84, which seat in a series of detents 83 in the swivel base 86 as shown in FIG. 5F. By manually overcoming the resultant force of the ball plungers 82, the user is able to swivel the swivel block 84 with respect to the swivel base 86 without the use of tools.

Referring to FIG. 5G, by means of a studded finger knob 88 and dovetail nut 90, the swivel base 86 can be affixed to any part containing a corresponding dovetail groove. Also, for extra versatility and referring to FIG. 5A, any part with an expandable dovetail (i.e. connector block assembly 36, pivot assembly 64, etc.) can engage with the dovetail groove 26 in the swivel base 86. Referring to FIG. 5G, a bolt 92, the axis of which coincides with the axis of rotation of the swivel, affixes the swivel base 86 to the swivel block 84. As with the connector block assembly 36 and the pivot assembly 64, the swivel block 80 also contains a male dovetail clamping system that includes a male dovetail 27, a removable knob assembly 38, socket 48, and nut 50. Operation of the male dovetail clamping system is identical to that described above for the pivot assembly 64.

The Wheel Block Assembly

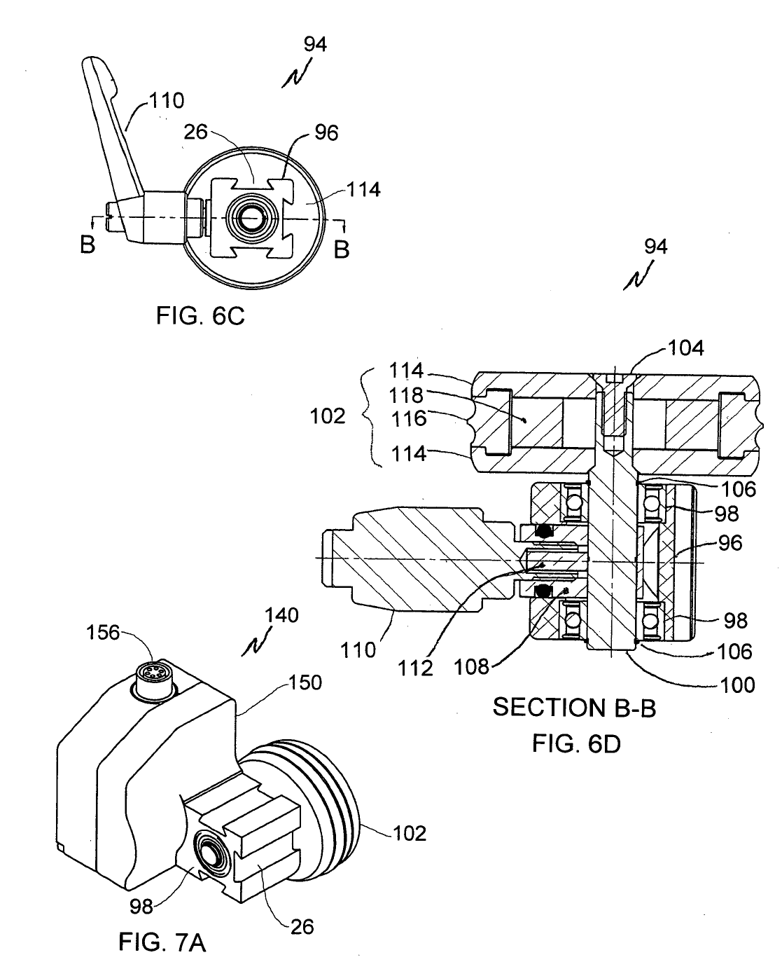

Referring to FIGS. 6A through 6D, the wheel block assembly, identified generally by reference numeral 94, is shown. Referring to FIG. 6A, the wheel block assembly has a block 96 with dovetail grooves 26 into which components having male dovetails may be affixed and which includes a wheel assembly 102 affixed to an axle 100 which is free to rotate about its axis. Referring to FIG. 6D, an optional brake 108 may be included which, when applied, locks the axle 100 and wheel assembly 102 to the block 96.

Referring to FIG. 6D, block 96 houses a set of bearings 98 and an axle 100 to which is affixed a wheel assembly 102 by means of a machine screw 104. The bearings 98 and axle 100 are retained in the block 96 with retaining rings 106. Referring to FIG. 6C, the block 96 contains dovetail grooves into which can be attached any male dovetail clamping component.

Referring to FIG. 6D, it also may contain a brake 108 which is a cylindrical part with a cross hole through which axle 100 is inserted. It also includes a threaded hole down its axis into which is threaded a brake handle 110. The braking action is activated by turning the brake handle 110 clockwise so that a brake insert 112 and the brake 108 together clamp the axle 100, thus preventing it from turning. Counterclockwise rotation of the brake handle 110 releases the brake.

The Wheel Assembly

Referring to FIG. 6D, wheel assembly 102 consists of two wheel halves 114 and a centralizing ring 116. Since the majority of applications will be on ferrous materials, a magnet 118 may also be used to attract the wheel assembly 102 to the material being inspected. The centralizing ring 116 contains two smoothly contoured grooves which act as collecting locations for ferrous debris which tends to stick to the magnetic wheel 102 and hamper the ability of the wheel to roll. The smoothly contoured grooves can be periodically wiped clean by the user. Alternatively, the centralizing ring 116 could be coated with an elastomer to increase the ability to roll smoothly over debris.

The Encoded Wheel Block Assembly

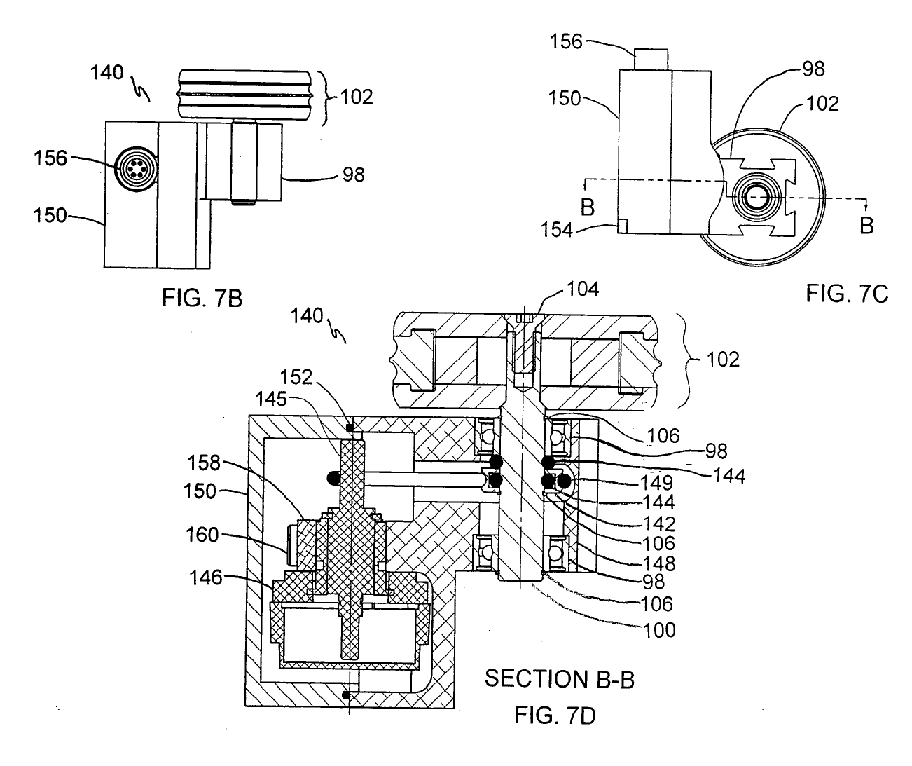

Referring to FIGS. 7A through 7D, the encoded wheel block assembly, identified generally by reference numeral 140, is similar to the wheel block assembly 94 except the brake 108, brake insert 112, and brake handle 110 are omitted. Referring to FIG. 7D, in their place is an encoder 146 which is coupled through a series of components to the wheel assembly 102.

Referring to FIG. 7D, as with the wheel block assembly 94, encoded wheel block assembly 140 has two bearings 98, an axle 100, and a wheel assembly 102 retained with a machine screw 104. These components are contained within an encoder block 148 which is similar to wheel block 96 except it is modified to house the encoder 146. The encoder 146 is clamped to the encoder block 148 with a clamp 158 and bolts 160. The encoded wheel block assembly 140 also contains a third retaining ring 106 which provides a shoulder to locate pulley 142 on the axle 100. An o-ring 144 is compressed radially between an internal groove in the pulley 142 and the axle 100 so that the pulley 142 and axle 100 rotate at the same rate. A second o-ring 144 is compressed axially between the bearing 98 and the pulley 142 to act as a flexible spacer to eliminate play as well as aid in driving the pulley 142. O-ring 149 serves as a drive belt to couple the pulley 142 to the shaft 145 of the encoder 146. A cover 150 and an o-ring 152 protect the encoder 146 from the environment. The cover 150 is attached to the encoder block 148 with bolts 154. An electrical receptacle 156 is housed in the cover 150 and provides the user with a means of completing the electrical connections for the encoder 146.

The Probe Holder Assembly

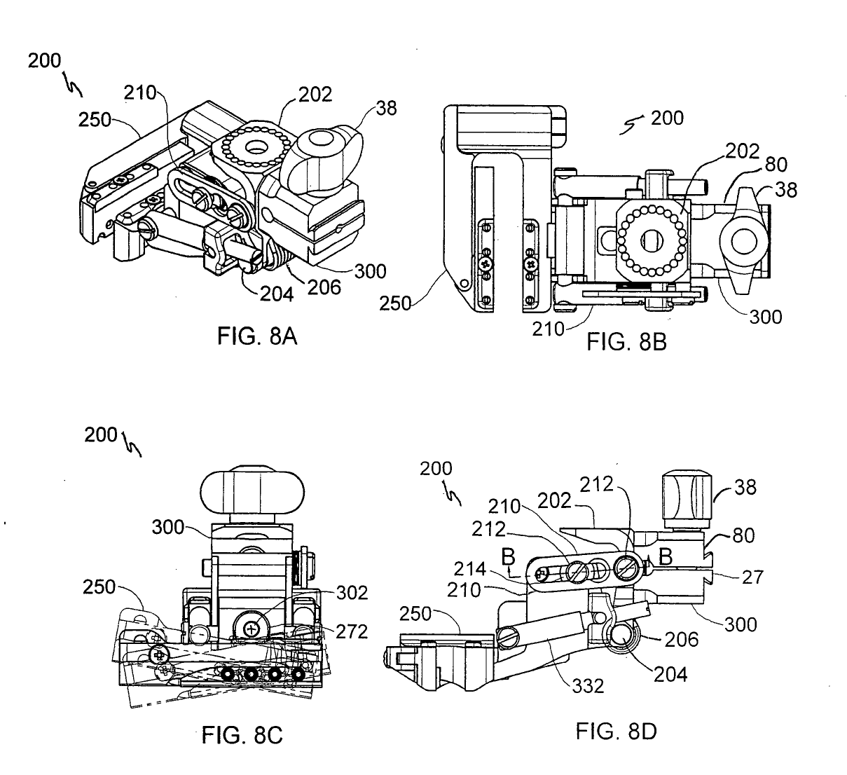

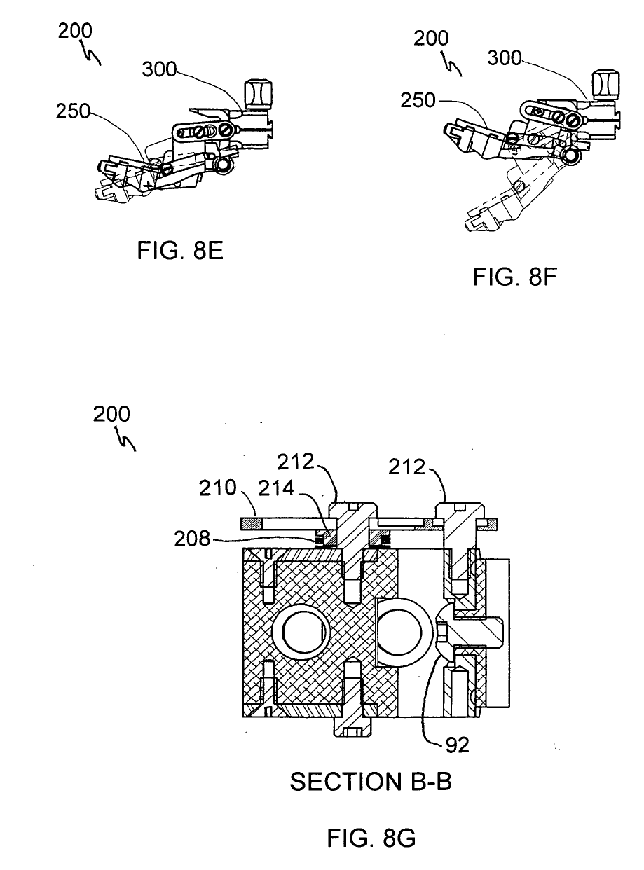

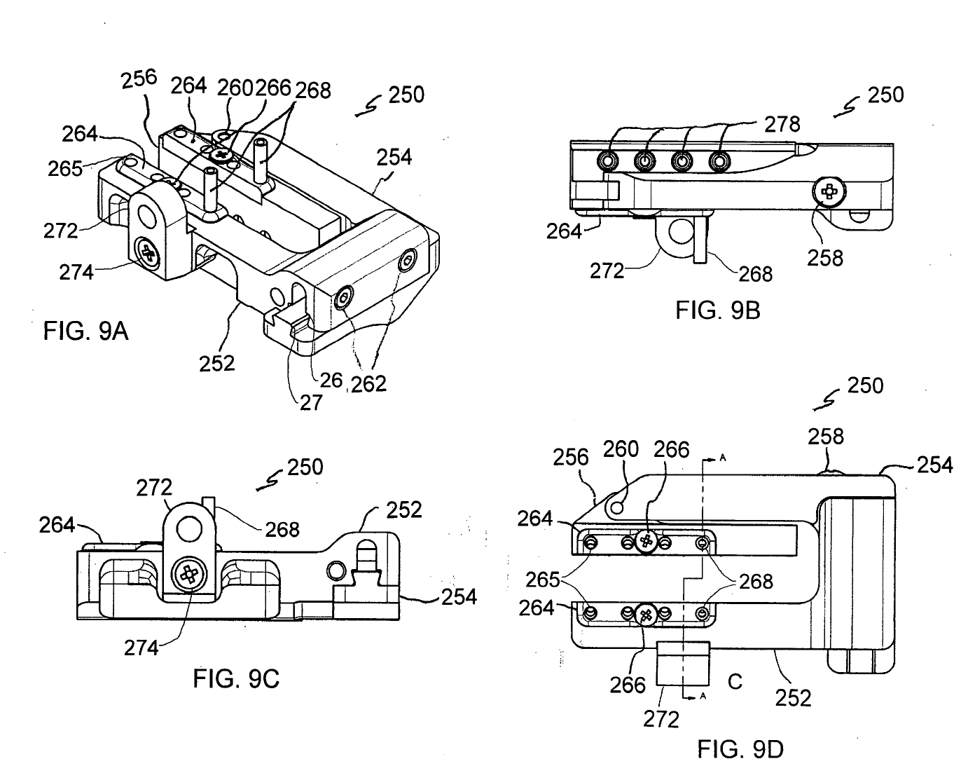

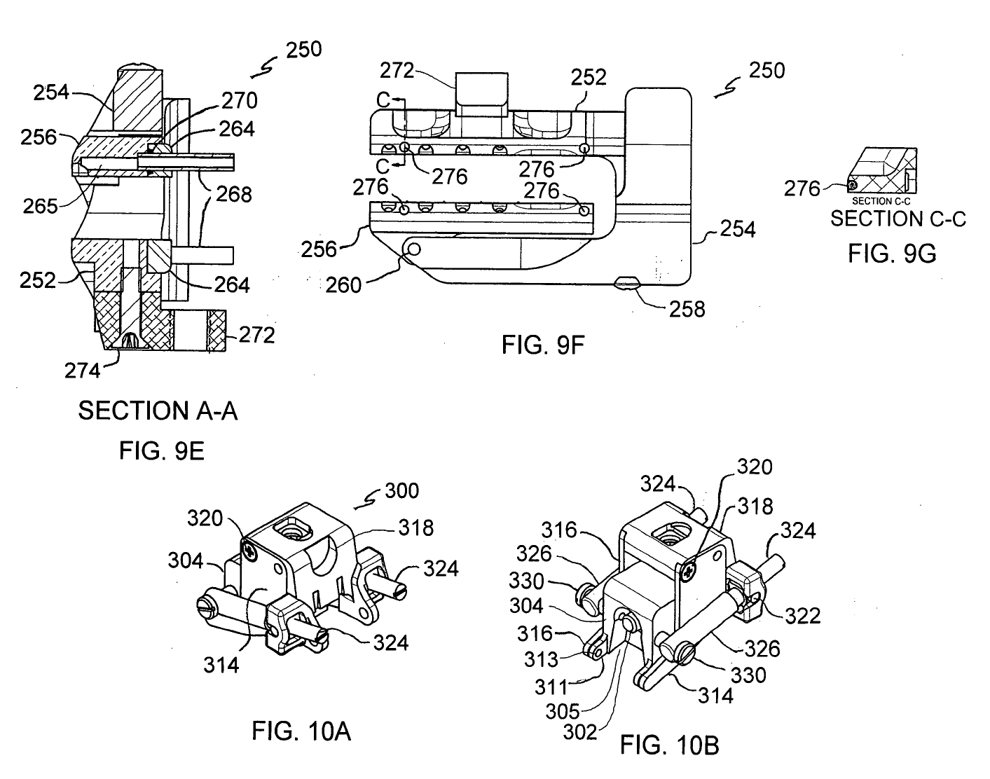

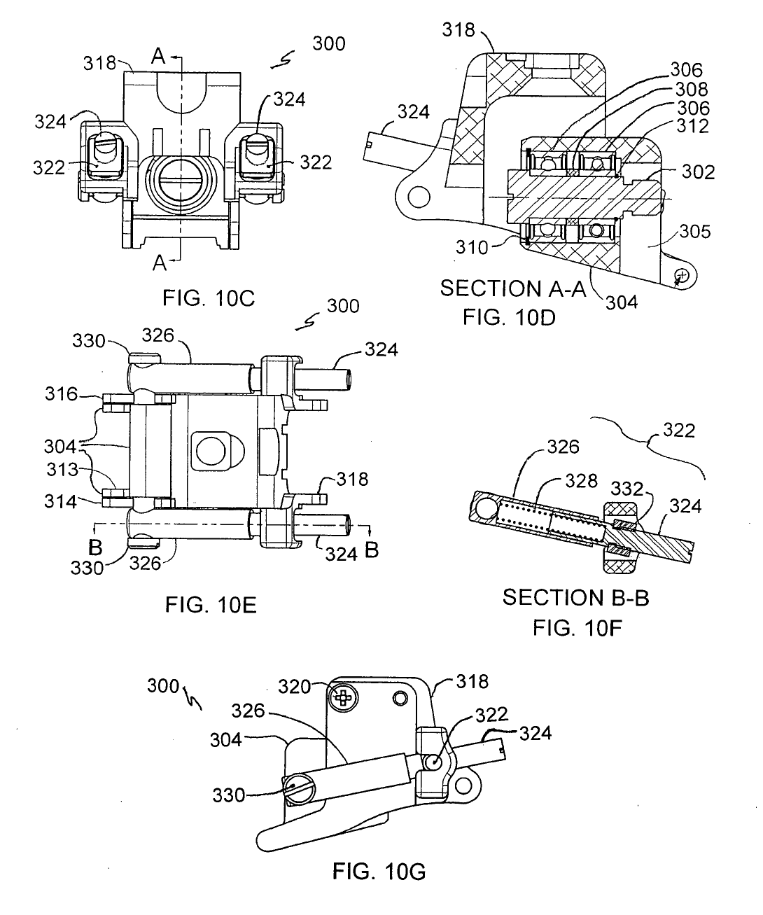

Referring to FIGS. 8A through 8G, the probe holder assembly, identified generally by reference numeral 200, provides a means of holding an inspection probe in a manner that allows the probes bottom face to remain in proper contact with the inspected material's surface. Referring to FIGS. 9A through 10G, the probe holder assembly is made up of two parts: a probe clamp assembly 250, and a probe pivot assembly 300. The probe clamp assembly 250 shown in FIGS. 9A through 9G physically holds the probe, while the probe pivot assembly 300 shown in FIGS. 10A through 10G provides the two degrees of freedom required for the probe to follow any slight irregularities in the inspected material's surface.

Referring to FIG. 8C the probe holder assembly 200 consists of the probe clamp assembly 250 affixed to the probe pivot assembly 300 by means of threading shaft 302 into bracket 272. FIG. 8C also illustrates the range of motion of the first degree of freedom produced by the coupling of these two components. Another degree of freedom inherent within the probe pivot assembly 300 is illustrated in FIG. 8E.

Referring to FIG. 8D, a bracket 202 is affixed to the lugs of the probe pivot assembly 300 with a pin 204, which acts as a pivot axis around which the probe pivot assembly 300 and probe clamp assembly 250 both rotate. The range of rotation of this pivot is shown in FIG. 8F. Referring to FIG. 8A, a torsion spring 206 affixed about the pin 204 applies a downward moment on the probe pivot assembly 300, causing the heel of the probe clamp assembly 250 to swing down onto the inspected material's surface. Referring to FIG. 8D, in order for the inspection probe to remain properly seated on the inspected surface, the toe of the probe clamp assembly 250 must have an approximately equal force to that on the heel. This is accomplished by adjusting the force exerted by the mechanical spring strut 332 contained in the probe pivot assembly 300. In effect, the torsion spring 206 applies a force on the heel of the probe clamp assembly 250 to obtain the movement shown in FIG. 8F, while the mechanical spring strut 332 applies a force to the toe to obtain the movement shown in FIG. 8E. The effective force applied on the heel of the probe clamp assembly 250 by the torsion spring 206 must be matched by the effective force on the toe by the mechanical spring strut 332. Due to the inherently near constant spring rate of the torsion spring 206, one setting of the mechanical spring strut is generally adequate for most applications.

Referring to FIG. 8G, in order to reduce the awkwardness in either setting the scanner on or removing the scanner from the inspected surface, a latching mechanism is included in the probe holder assembly 200 so that when the user lifts the probe clamp assembly 250 and probe pivot assembly 300 to its uppermost extent, a wave spring 208 forces a latch 210 to catch the head of a latch bolt 212 and prevents the torsion spring 206 from forcing the probe clamp assembly 250 back onto the inspected surface. A plastic bushing 214 is positioned between the latch 210 and the wave spring 208 to provide a lower friction rubbing surface. A second latch bolt 212 acts as a pivot axis for the latch 210. The user disengages the latch 210 simply by applying a force on the latch 210 so that the wave spring 208 compresses and the counterbored portion of the latch 210 disengages with the head of the latch bolt 212.

Referring to FIG. 8A, the bracket 202 connects to a swivel block 84 (shown in FIG. 5G) in the exact same way as the swivel base 86 does in the swivel assembly 80, thus allowing the user to quickly and easily swivel the probe holder assembly 200 about the axis of the attachment bolt 92, if desired. For additional versatility, the connection may be made on the back face of bracket 202, as shown, or on the top face. As in the swivel assembly 80, the swivel block 84 would also include a plurality of spring plungers 82, a removable knob assembly 38, a socket 48, and a nut 50.

The Probe Clamp Assembly

Referring now to FIGS. 9A through 9G, more detail on the probe clamp assembly 250 will be given. Probe clamp assembly 250 is intended to be a component capable of clamping inspection probes of various sizes and shapes and also to provide a means for attaching the inspection probe to the probe pivot assembly 300 described below. The design of the clamping parts is such that one end is open, allowing the inspection probe to be clamped at the outer extent of the probe clamp assembly 250 with no extra hardware extending past the face of the inspection probe. Note that, in this description, “outer extent” and “outboard” are used to indicate to the left in FIG. 9D, and “inboard” indicates to the right. This is beneficial in situations where two inspection probes must operate facing each other with a minimal separating distance. This is unlike conventional probe holding systems which have parts outboard of the inspection probe face, thus physically requiring a probe separation distance which is possibly greater than that allowed for the job. The probe clamp assembly 250 also provides a means of supplying the coupling fluid commonly required by ultrasonic probes to the inspection probe/inspected material interface.

Referring to FIG. 9A, the probe clamp assembly 250 consists of three main parts: the fixed clamp half 252, the movable clamp half 254, and the clamp jaw 256. A dovetail groove 26 in the fixed clamp half 252 mates with a corresponding male dovetail 27 on the movable clamp half 254 so as to provide a method of sliding one within the other. Two screws 262 provide a means of adjusting the width of the dovetail groove in the fixed clamp half 254 so as to eliminate any excessive play in the sliding action. This allows the parts to be manufactured with looser tolerances. Clamping force is exerted between the fixed clamp half 252 and the movable clamp half 254 by rotating the screw 258 clockwise. The clamp jaw 256 is affixed to the movable clamp half 254 with a pin 260. The purpose of pinning the clamp jaw 256 to the movable clamp half 254 is to maintain parallelism between the clamp jaw 256 and the fixed clamp half 252 so that the inspection probe is clamped with relatively uniform pressure across its width. Without this pinned connection, the deflection in the movable clamp half 254 due to the clamping force would cause the probe to be held primarily on its inboard edge. Referring to FIG. 9D, the pin 260 is positioned so that the clamping force exerted on the clamp jaw 256 by the movable clamp half 254 via the pin 260, which is located near the outer extent of the clamp jaw 256 to make certain that even the smallest probes can be held flush with the outer extent of the probe clamp assembly 250.

Both the fixed clamp half 252 and the clamp jaw 256 contain recesses into which a manifold bar 264 is held with a screw 266. The manifold bar 264 contains a series of holes 265 into which the user can insert one or more stainless steel irrigation tubes 268. Referring to FIG. 9E, an o-ring 270 provides a seal around the tube 268 as well as a means of retaining the tube 268 in the manifold bar 264 by means of radial compressive force. Channels in the fixed clamp half 252 and clamp jaw 256 create a pathway for the coupling fluid to pass and exit as close as possible to the inspection probe/inspected material interface.

Referring to FIG. 9C, a mounting bracket 272 is affixed to the fixed clamp half 252 with a bolt 274. The threaded hole in the bracket 272 is used to mount the probe clamp assembly 250 to the probe pivot assembly 300.

Referring to FIG. 9F, since the surface on which the probe clamp assembly 250 operates is typically rough steel, four hardened balls 276 may be pressed into holes in the clamp jaw 256 and the fixed clamp half 252 to increase the wear resistance.

Referring to FIG. 9B, four cone point set screws 278 are threaded into the clamp jaw 256 to provide an additional method of gripping the inspection probe.

The Probe Pivot Assembly

Referring to FIGS. 10A through 10G, more detail on the probe pivot assembly 300 will now be given. Probe pivot assembly 300 is a component that probe clamp assembly 250 is affixed to, and provides two degrees of freedom. The degrees of freedom are necessary to keep the inspection probe clamped by clamp assembly 250 in proper contact with the surface being inspected, which may have slight irregularities.

Referring to FIG. 10D, probe pivot assembly attaches to the probe clamp assembly 250 by threading a shaft 302 into the bracket 272 shown in FIG. 9C of the probe clamp assembly 250. The shaft 302 is retained in a block 304 by means of a pair of bearings 306, a spacer 308, an internal retaining ring 310, and an external retaining ring 312. Once the probe clamp assembly 250 is assembled on the shaft 302, the bearings 306 allow the probe clamp assembly 250 to rotate back and forth slightly about the axis of the shaft 302. This is the first rotational degree of freedom that the probe pivot assembly 300 provides. The block 304 has a recess 305 into which the bracket 272 of the probe clamp assembly 250 fits. The sides of the recess act as stops to limit the rotation of the probe clamp assembly 250 to plus or minus 10°.

Referring to FIG. 10B, the block 304 has two tangs 311 with holes into which fit a pin portion 313 of either the left-hand side (LHS) plate 314, or the right-hand side (RHS) plate 316. The pin portion is a small round boss machined on the LHS plate 314 and RHS plate 316. It provides the second rotational degree of freedom by allowing the block 304 to rotate about the axis of the pin portions 313. This axis of rotation is purposely located as close as possible to the inspected surface so as to minimize the overturning moment induced on the probe clamp assembly 250 while translating across the inspected surface. Referring to FIGS. 10A and 10B, the LHS plate 314 and RHS plate 316 are secured to a common block 318 with screws 320.

A mechanical spring strut 332 provides a means for applying a moment on the block 304 about the axis of the second rotational degree of freedom. Referring to FIG. 10F, four components make up the mechanical spring strut 332: a partially threaded cylinder 324, a slightly larger cylinder 326, a compression spring 328, and a trunnion block 322. The partially threaded cylinder 324 slides within the bore of the larger cylinder 326 and also contains the compression spring 328 within its own bore. Referring to FIG. 10E, a cross-hole near the end of the larger cylinder 326 is used to pin the mechanical spring strut 332 to the block 304 with a pivot bolt 330. Referring to FIG. 10G, each side of the trunnion block 322, into which is threaded the partially threaded cylinder 324, contains a small round boss which, when contained within a set grooves in the block 318, form an axis on which the mechanical spring strut 332 pivots. Since the partially threaded cylinder 324 is threaded into the trunnion block 322, it may be used for increasing or decreasing the preload on the compression spring 328 simply by rotating the partially threaded cylinder 324 clockwise or counterclockwise, respectively, about its axis. A screwdriver slot is provided in the partially threaded cylinder 324 for this reason.

Swing Arm Probe Holder

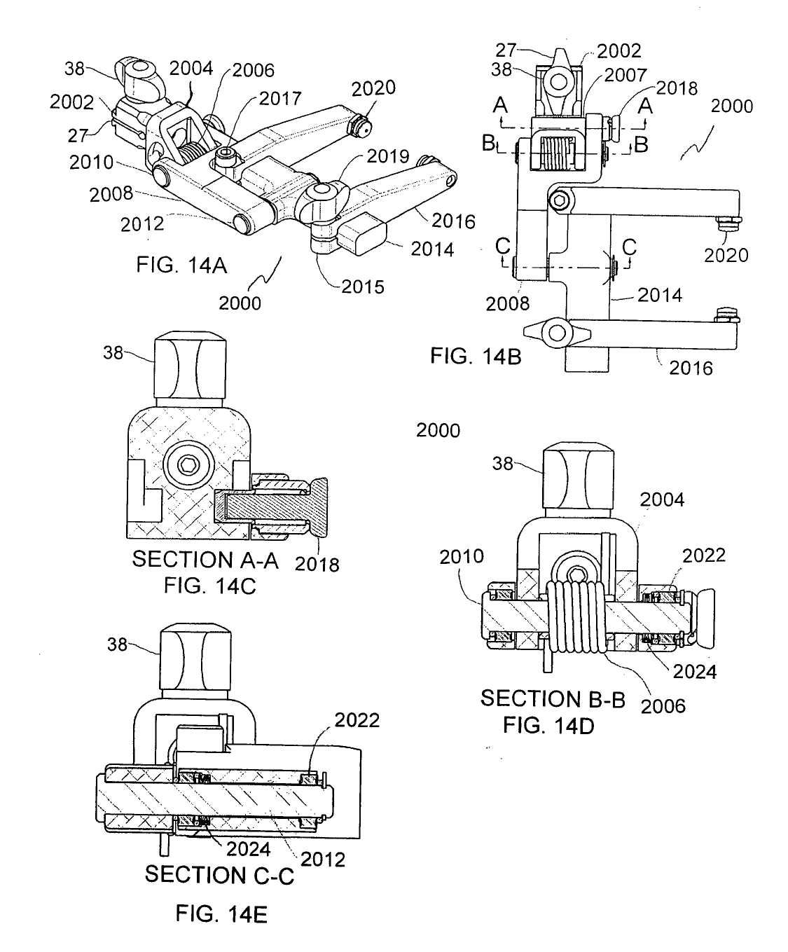

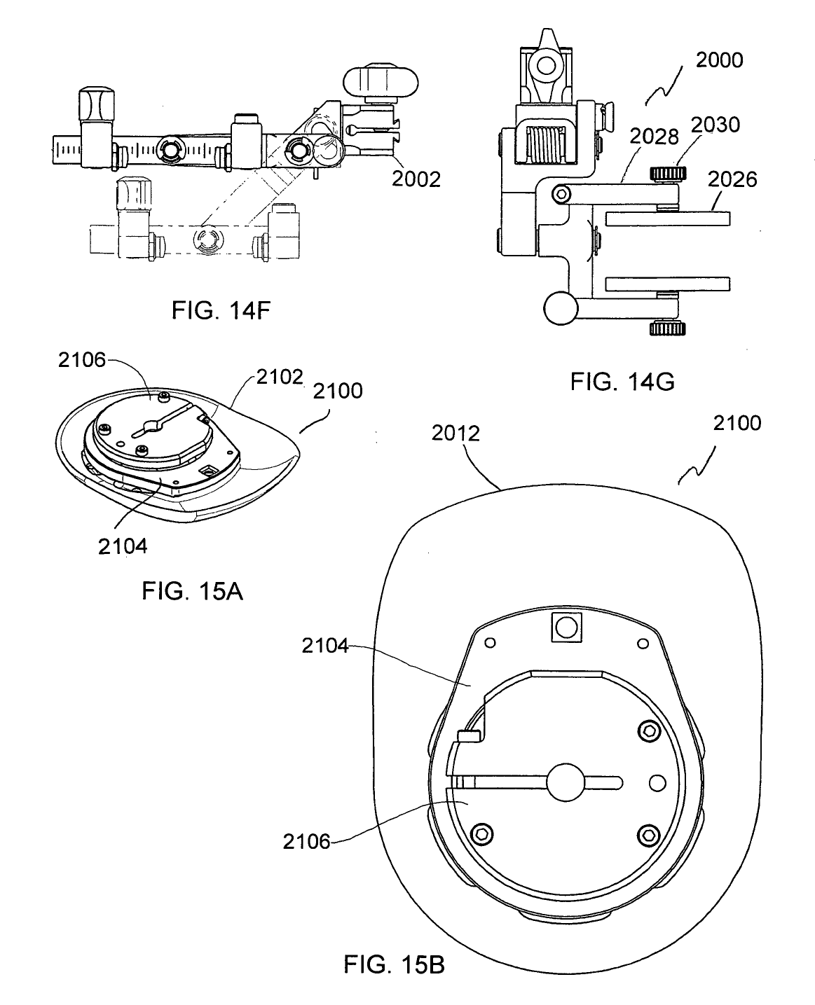

Referring to FIGS. 14A through 14G, the swing arm probe holder, identified generally reference numeral 2000, provides an alternative means of holding an inspection probe in a manner that allows the probes bottom face to remain in proper contact with the inspected material's surface. The swing arm probe holder 2000 is designed to hold many different varieties and shapes of probes.

Referring to FIG. 14A, swing arm probe holder 2000 consists of a swivel connecting block 2002. As with the connector block assembly 36 and the pivot assembly 64, the swivel connecting block 2002 has a male dovetail clamping system involving a removable knob assembly 38, and socket and nut, which were describe previously. Operation of the male dovetail clamping system is identical to that described for the pivot assembly 64 above. Referring to FIG. 14B, the pivot bracket 2004 is fastened to the swivel connector block 2002 at point 2007 by means of a fastener and radial teeth that mesh together. This allows the swivel connector block 2002 to be rotated with respect to the pivot bracket 2004. The meshing teeth prevent rotational slippage between the components. Referring to FIGS. 14A and 14D, the torsion pivot pin 2010 is solidly affixed to the pivot bracket 2004. Two bearings 2022 fixed in the swing arm 2008 along with the torsion pivot pin provide a means of fastening the swing arm 2008 to the pivot bracket 2004. The torsion pivot pin 2010 allows the swing arm 2008 to rotate with respect to the pivot bracket 2004. A torsion spring 2006 surrounds the torsion pivot pin 2010, with each of its respective legs against the pivot bracket 2004 and the swing arm 2008. This applies a constant downward force of the swing arm 2008 in respect to the pivot bracket 2004 to obtain movement as shown in FIG. 14F. Referring to FIGS. 14A and 14E, a second crossbar pivot pin 2012 is attached to the swing arm 2008. Two bearings 2022 fixed in the crossbar 2014 allow rotation of the crossbar 2014. Both the torsion pivot bearing set shown in FIG. 14D and crossbar pivot bearing set shown in FIG. 14E use a wave spring 2024 to eliminate backlash. Referring to FIG. 14 B, two probe holder arms 2016 are mounted to the crossbar 2014. Referring to FIG. 14A, these probe holder arms 2016 are mounted to the crossbar 2014 by a split clamp 2015 and tightened by either a fastener 2017 or a thumb knob 2019. The probe holder arms 2016 are able to slide together and apart on the crossbar 2014 to allow for adjustment of different probes.

There are two main methods of fixing a probe to the swing ann probe holder 2000. The first, shown in FIG. 14B is with buttons 2020. If the inspection probe to be used has pivot holes or pivot holes can be added to the probe button, 2020 can be fixed to the probe holder arms 2016 and inserted in the inspection probe pivot holes to provide a second axis of rotation required to ensure the inspection probe is in good contact with the inspection surface at all times. Different configurations of buttons 2020 are to be used with different styles and sizes of probe pivot holes.

The second method, shown in FIG. 14G, is to clamp the inspection probe with two opposing clamp plates 2026. This method is necessary for inspection probes that do not have pivot holes. The clamp plates 2026 are attached to the probe holder arms 2028 with a threaded pivot knob 2030. The threaded pivot knob 2030 allows an inspection probe to be clamped and held in the swing arm probe holder 2000 while still allowing the second axis of rotation needed to keep the inspection probe flat on the inspection surface. Referring to FIG. 14C, in order to reduce the awkwardness in either setting the scanner on or removing the scanner from the inspected surface, a latching mechanism 2018 is included in the swing arm probe holder assembly 2100 to keep the swing arm 2008 and all other affixed components to its uppermost extent.

Virtual Pivot Probe Holder

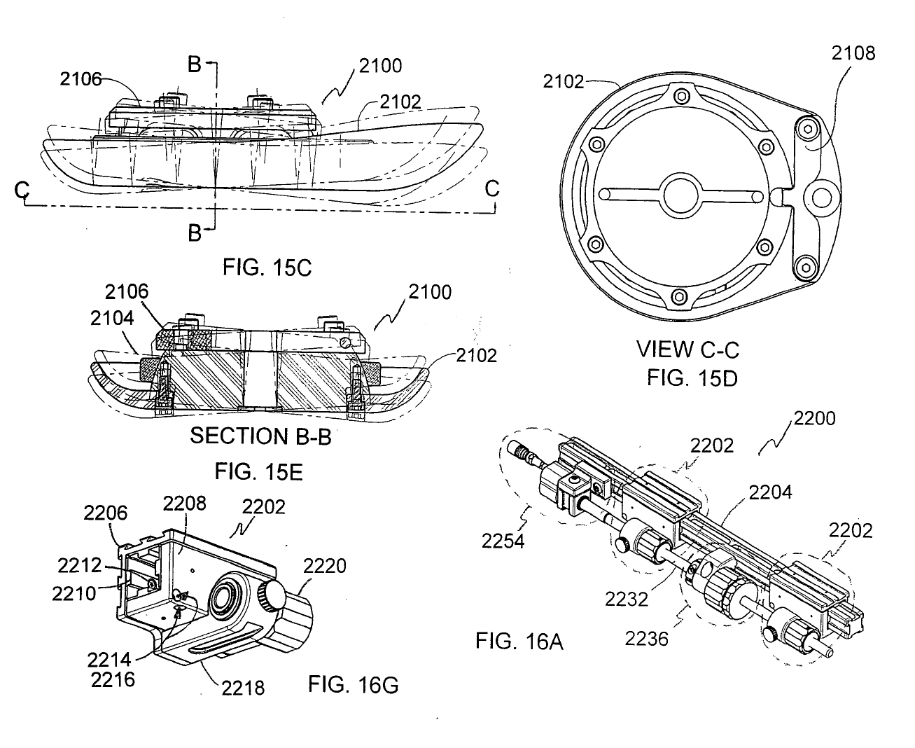

Referring to FIGS. 15A through 15E, the virtual pivot probe holder, identified generally by reference numeral 2100, is used to translate probe(s) across a surface to be inspected. The virtual pivot probe holder 2100 is designed so that when it is mounted to a spring loaded vertical slide, the probe remains in contact with the inspection surface at all times. The virtual pivot probe holder can be adapted for any size or shape of probe or probes.

Referring to FIG. 15A, the virtual pivot probe holder consists of a shoe 2102. This shoe 2102 is designed with raised ramped outer edges. This allows the shoe 2102 to ride over irregularities and changing surface geometry on the inspection surface. Referring to FIG. 15C, the shoe 2102 has a portion of a sphere built into its geometry. The center point of the spherical portion of the shoe 2102 is below the inspection surface. Referring again to FIG. 15A, a retainer plate 2104 has a portion of the inverse sphere of the shoe 2102. This inverse sphere portion acts as a “socket” for the shoe 2102 to travel in. The shoe 2102 is free to rotate in the socket, thus allowing the shoe 2102 to articulate and keep the probe perpendicular to the inspection surface. The shoe 2102 resists flipping over when coming in contact with an obstacle on the inspection surface due to the center point of the sphere being below the inspection surface. Referring to FIG. 15D, an anti-rotation tab 2108 is fastened to the retainer plate 2104. The tab 2108 fits in a notch in the shoe 2102. This prevents rotation about the axis perpendicular to the face of the shoe 2102. Referring to FIG. 15B, a clamp plate 2106 is mounted on top of the shoe. This clamp plate 2106 retains the shoe 2102 in the retainer plate. The clamp plate 2106 also provides a means of clamping the probe to the virtual pivot probe holder. Referring to FIG. 15E, the retainer plate 2104 has a mounting pocket and hole used to mount the virtual pivot probe holder assembly to a spring loaded vertical slide assembly.

The Wheel Base Assembly

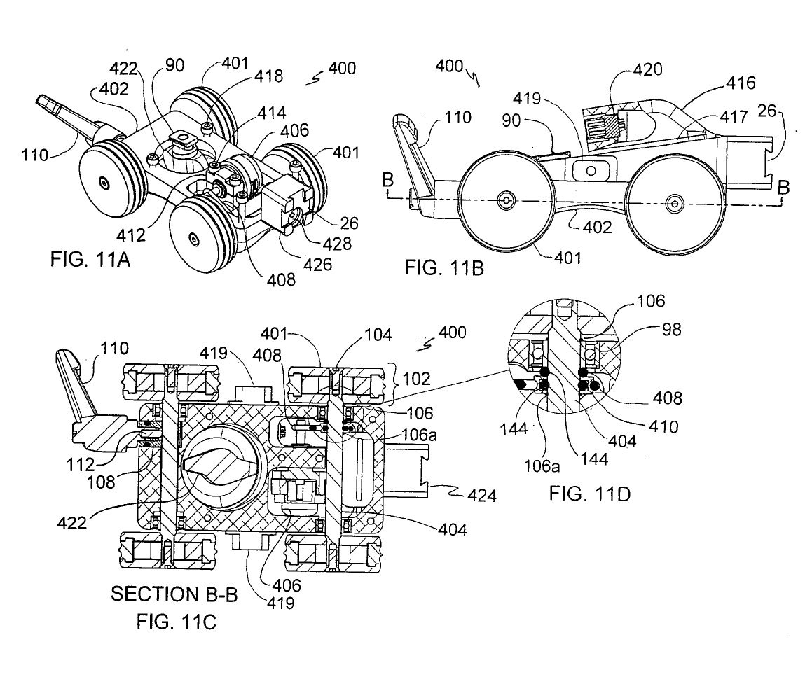

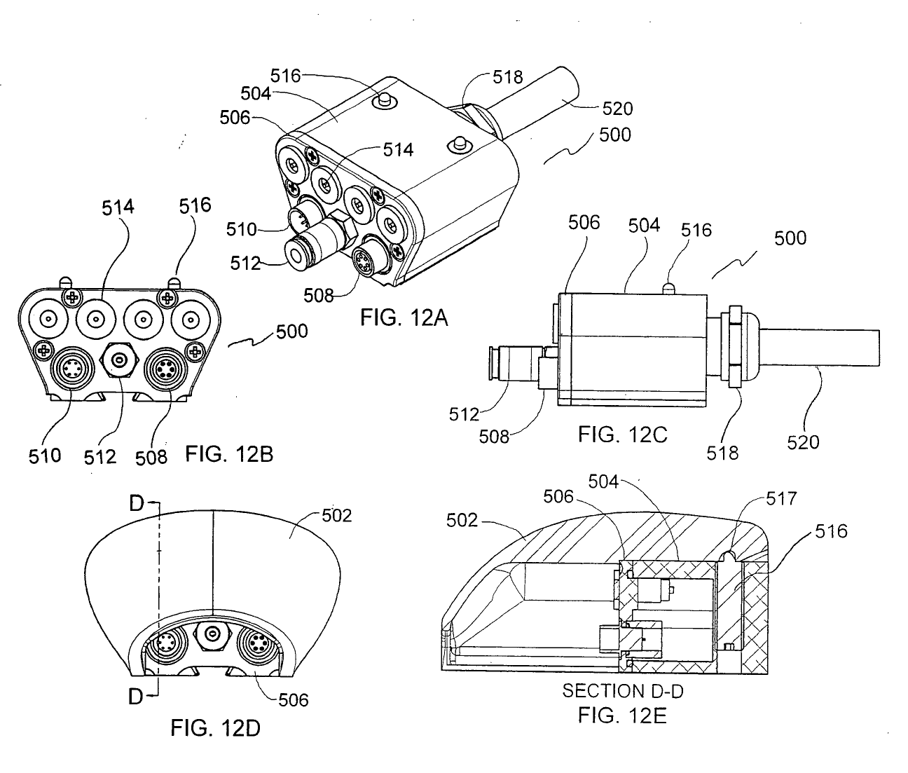

Referring to FIGS. 11A through 11D, the wheel base assembly, generally identified by reference numeral 400, is a rigid body cart with four wheels 401 on which various components can be mounted. This compact, ergonomic base enables an operator to translate one or more probes on cylindrical surfaces in the circumferential or longitudinal orientation, with encoded position feedback. The wheel assemblies 102 are positioned on the lower base 402 such that it can be driven either circumferentially or longitudinally on cylindrical surfaces having a radius in the range of 1.5″ to infinity. It also serves as a docking terminal for the umbilical cable 500 shown in FIG. 12C, which conveys the probe and encoder signals to the signal processing equipment and supplies coupling fluid to the probes.

Commonly, the wheel base assembly 400 can be attached to ferrous objects by means of magnetic attraction through magnets in the four wheels 401. However, for non-ferrous materials alternate means such as a linked chain or flexible material, with rolling wheels to reduce friction, can be attached to the front and back forming a continuous restraining loop around a cylinder.

Referring to FIG. 11B, the wheel base assembly 400 consists of a split housing comprised of lower base 402, and upper cover 416, each having a cavity cut into the opposing mating surfaces. When joined together with four screws 418 shown in FIG. 11A, lower based 402 and upper cover 416 form a watertight enclosure for the encoder 406 and preamp circuit board.

Referring to FIG. 11C, the lower base 402 is fitted with two parallel axles 404 that have a wheel assembly 102, fixed to either end with a machine screw 104. Referring to FIG. 11D, the axle/wheel assembly is attached to the lower base 402 by means of sealed ball bearings 98 on either end. Axles 404 and bearings 98, are held in place axially by means of snap rings 106 set into a groove on either end of the axles 404.

Referring to FIGS. 11C and 11D, position encoding is accomplished by means of a rotary encoder 406 driven by an O-ring belt 408 from the axle pulley 410 which is secured to axle 404 with O-ring 144 compressed radially between an internal groove in the pulley 410 and the axle 404 so that the pulley 410 and axle 404 rotate at the same rate.

Referring to FIG. 11D, the axle 404 also contains a third retaining ring 106a which provides a shoulder to locate pulley 410 on the axle 404. A second o-ring 144 is compressed axially between the bearing 98 and the pulley 410 to act as a flexible spacer to eliminate play as well as aid in driving the pulley 410. Referring to FIG. 11A, the encoder body 406 is secured to the lower base 402 with clamp bar 412 and two screws 414.

Referring to FIG. 11C, a friction brake assembly comprised of parts 108, 110, and 112, identical to that described above, is provided on the second axle to prevent unwanted movement of the wheel base assembly 400 when not in scanning mode.

Referring to FIG. 11B, the upper cover 416 is formed with a male dovetail section to slide into a matching dovetail groove in the umbilical connector assembly 500. The male dovetail has two sections, a fixed potion 417 which acts as a guide when sliding the two components together, and a clamping section 90 which serves to lock the parts to each other. Referring to FIG. 11A, a wing knob 422 with threaded male end that fits into the dovetail clamp 90 and accessible from the bottom is used to provide the clamping force. Referring to FIG. 11B, a miniature six pin electrical connector 420 is fitted into the upper housing 416 on an axis parallel to the dovetail slide 417 which engages with a companion connector (not shown) in the umbilical connector assembly 500 forming a protected, watertight electrical connection for the encoder signals.

Referring to FIGS. 11A and 11B, component 424 is a dovetail bracket that will fit in three locations on the upper lid 416 of the wheel base assembly 400 for the purpose of attaching one or more probe holding assemblies 200 to the wheel base assembly 400. A rectangular pocket (not shown) is milled into the dovetail bracket 424 that locates it accurately and securely with a single screw fastener 428 to the matching rectangular bosses 419 on the upper lid 416 of the wheel base assembly 400. Two dovetail grooves 26 that are oriented at right angles to each other on the opposite face are used to attach the probe holder assembly 200 directly to the wheel base assembly 400, or with intermediate components such as arm assembly 600 described below. The three positions 419, together with the crossed dovetail grooves 26, provide a high degree of flexibility for mounting one or more probe holder assemblies.

Umbilical Assembly

Referring to FIGS. 12A, 12B and 12C, umbilical assembly, identified generally by reference numeral 500, is used to conduct various combinations of sensor signals, encoder signals, power, communication signals, and coupling fluid.

Referring to FIG. 12A, the umbilical assembly 500 consists of a breakout box 504, a breakout box cap 506, a 6-pin sealed socket connector 508, a 6-pin sealed connector 510, a quick connect fitting 512, four sealed coax connectors 514, two spring plungers 516, a strain relief fitting 518, and an umbilical cable 520. The breakout box 504 utilizes a female dovetail to mate with components having male dovetail grooves. A strain relief fitting 518 is threaded into the breakout box 504 and uses a rubber ferrule to provide environmental sealing and strain relief to the umbilical cable 520. The umbilical cable 520 consists of power, communication, encoder signal, coax conductors and a coupling fluid tube all contained in a poly urethane jacket. The breakout box cap 506 is fastened to the break out box 504 with threaded fasteners and a o-ring seal to keep the breakout box 504 water tight. Four sealed coax connectors 514, a 6-pin sealed socket connector 508, a 6-pin sealed connector 510, and a quick connect fitting 512 are mounted in the face of the breakout box cap 506. Items 508, 510, 512 and 514 are connected their respective conductors of the umbilical cable 520 (not shown). Referring to FIG. 12E, two spring plungers 516 are threaded into the breakout box 504. The spring plungers 516 mate with notches 517 in the ergonomic handle 502 to keep the handle in place, but also to allow for easy removal of the handle 502.

Ergonomic Handle

Referring to FIGS. 12D and 12E, the ergonomic handle 502 is a component that is used to manage cabling and provide a sure grip when translating an assembly of components. Referring to FIG. 12E, the ergonomic handle 502 is designed to slide over the umbilical assembly 500 and register in slots on the wheel base 400 as discussed above with reference to FIG. 11B. Spring plungers 516 locate in notches in the ergonomic handle 502 allowing for easy installation and removal onto umbilical assembly 500. The ergonomic handle 502 has a groove in the center of the part to create a cavity 503 which can house external wiring to keep the handle area free of extra cables.

Arm Assembly

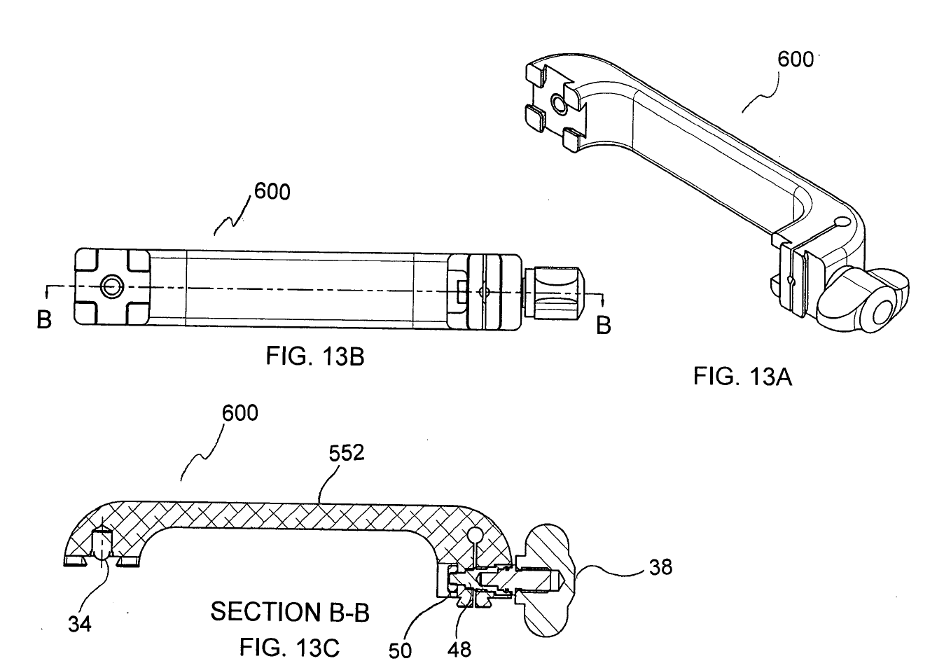

Referring to FIGS. 13A, 13B and 13C, arm assembly, identified generally by reference numeral 600, is used when scanning cylindrical surfaces in the circumferential direction. Specifically, the aim assembly 600 is designed to position the probe midway between the wheels 401 of the wheel base assembly 400 shown in FIG. 11A. This is highly advantageous, in that it allows for scanning of any radius of cylinder without having to adjust the probe position. The arm assembly 600 is primarily used with the simplified scanner assembly 700 shown in FIG. 19A. As with the pivot assembly 64, the arm assembly 600 contains a male dovetail clamping system involving a removable knob assembly 38, socket 48, and nut 50. Operation of the male dovetail clamping system is identical to that described for the pivot assembly 64 above.

The Lateral Probe Positioner Assembly

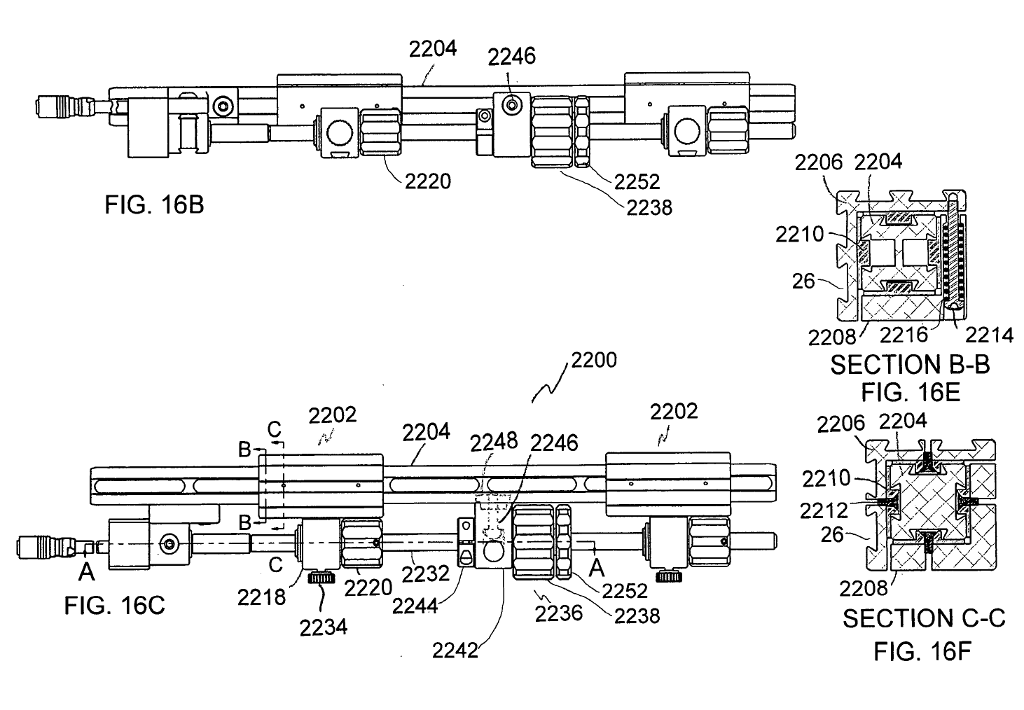

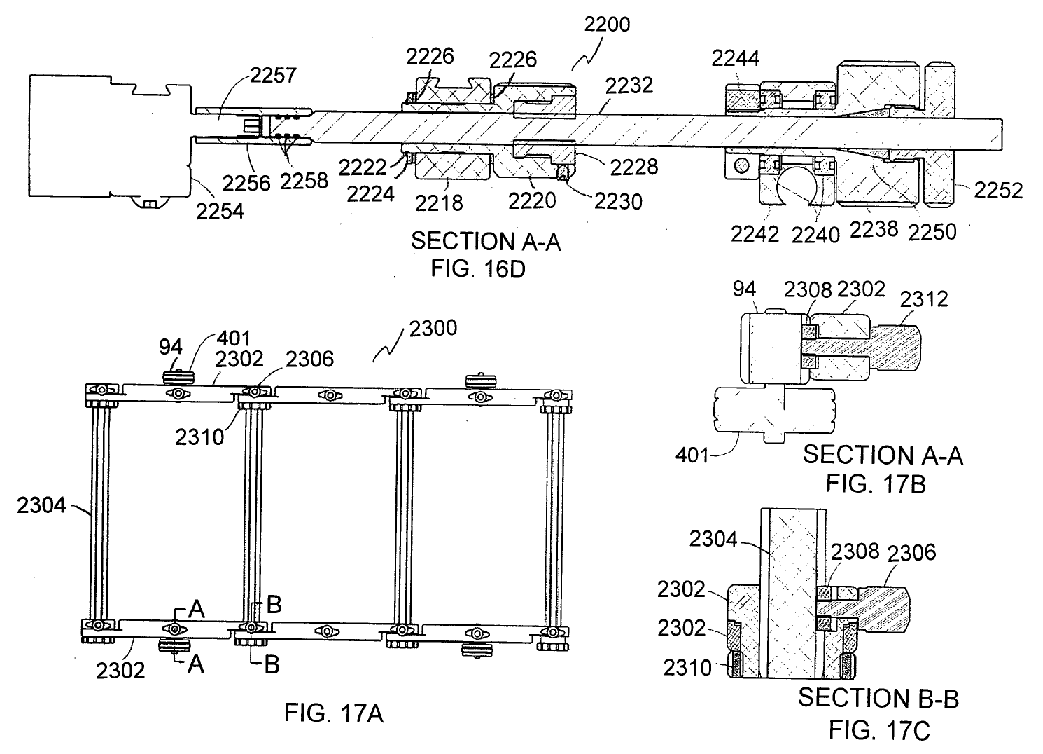

Referring to FIGS. 16A through 16G, the probe holder assembly, identified generally by reference numeral 2200, provides a means of translating one or two probe holders in a direction perpendicular to the primary scanning direction. This may be beneficial to an operator by allowing the probe(s) to track a weld which may not be perfectly straight. It also provides a means of quickly and controllably setting the distance between probes when two probes are used.

Referring to FIG. 16A, the lateral probe positioner assembly 2200 consists of one or more slide assemblies 2202 which are permitted to slide along a bar 2204. Referring to FIG. 16F, the slide assemblies 2202 consist of two angle members: an angle member 2206 with dovetail grooves 26 for mounting a probe holder, and an angle member 2208 without dovetail grooves. The inner faces of the angle members 2206 and 2208 are lined with friction-reducing wear pads 2210 retained with screws 2212. Referring to FIG. 16E, the angle members 2206 and 2008 are fastened together with screws 2214. Compression springs 2216 apply a load on the wear pads 2210 such that the slide assembly 2202 is retained on the bar with some preload. This eliminates any play the slide assembly 2202 may otherwise have.

Referring to FIGS. 16D and 16G, a bracket 2218 is fastened to the angle member 2206. A small knob 2220 is retained in a through hole in the bracket 2218, the axis of which is parallel to the direction of travel of the slide assembly 2202, with a washer 2222 and a retaining ring 2224. Referring to FIG. 16D, friction-reducing wear washers 2226 are located on either side of the bracket 2218. A lead screw nut 2228 is securely threaded into the small knob 2220 and permanently locked in place with a set screw 2230. A lead screw 2232 runs through and engages with the threads of the lead screw nut 2228.

Referring to FIG. 16C, if the lead screw 2232 is held stationary while the small knob 2220 is manually rotated about its axis, the slide assembly 2202 will translate along the bar 2204. This mode would be useful for setting the distance between two probes as the slide assemblies 2202 would move independent of each other.

If lock knob 2234 is engaged so that the small knob 2220 is not permitted to rotated within the bracket 2218, rotation of the lead screw 2232 with the main knob assembly 2236 will force the slide assembly 2202 to translate along the bar 2204. If two slide assemblies 2202 are present and if each of their lock knobs 2234 is engaged, rotation of the main knob 2238 would cause both slide assemblies 2202 to translate in the same direction at the same rate. This mode would be useful for keeping a pair of probes centered on a weld.

Referring to FIG. 16D, the main knob assembly 2236 consists of a main knob 2238 onto which are assembled two bearings 2240 which are housed in a bracket 2242 and held together with a clamp nut 2244. The clamp nut 2244 is assembled so that any play in the bearings 2240 is removed. The bracket 2242 is fastened to the bar 2204 with a screw 2246 and dovetail nut 2248. The main knob 2238 is rigidly attached to the lead screw 2232 by means of a collet 2250 compressed by a clamp knob 2252.

If positional data of the probe(s) is desired, an optional encoder module 2254 may be fastened to the bar 2204. A coupling 2256 threaded onto the shaft 2257 of the encoder module 2254 engages with a number of o-rings 2258 retained in grooves on the end of the lead screw 2232, thus driving the encoder module's shaft 2257.

The Sectional Frame Assembly

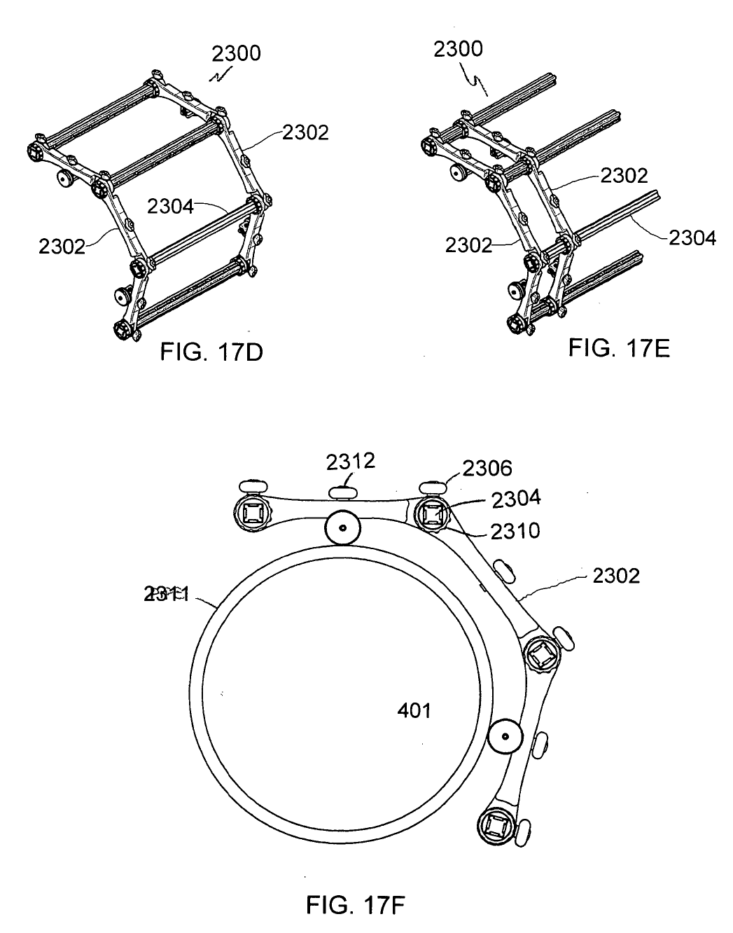

Referring to FIGS. 17A through 17F, the sectional frame assembly, identified generally by reference numeral 2300, is a frame suitable for scanning circumferentially around ferrous pipe or small vessels onto which probe holders and/or accessories may be attached. Sections of the frame may be added or removed as required. Also, it can be quickly and easily configured to match a broad range of pipe diameters. Magnetic wheels may be used to hold the scanner on the pipe.

Referring to FIG. 17A, there are two sets of side members 2302 conjoined by bars 2304 which run perpendicular to and pass through the end of each side member 2302. A tightening knob 2306 and dovetail nut 2308 fasten the bars 2304 to the side members 2302. Referring to FIG. 17C, each set of side members 2302 consists of two or more side members 2302 which are nested end to end and are rigidly fixed one to the other by means of a nut ring 2310. Each end of the side members 2302 contains a plurality of fine teeth (not shown) disposed about a common axis of rotation which engage with each other upon tightening of the nut ring 2310. When the nut ring 2310 is loosened, the related side members 2302 are free to rotate about the axis of rotation. Loosening all the nut rings 2310 allows the sectional frame assembly 2300 to be wrapped around the outer diameter of a pipe 2311, as shown in FIG. 17F. Upon tightening of all the nut rings 2310, the sectional frame assembly 2300 becomes rigid.

Referring to FIGS. 17A and 17B, there are four wheel block assemblies 94 fastened at the midpoints of the outermost side members 2302 with tightening knobs 2312 and dovetail nuts 2308. Their magnetic wheels 401 hold the scanner on the pipe.

Referring to FIGS. 17D and 17E, a useful feature of the sectional frame assembly 2300 is its ability to be configured so that both sets of side members 2302 may be positioned on one side of the weld. In this arrangement the probes may be cantilevered over the weld, which is useful in situations where both sides of the weld are not suitable for a scanner to operate on, such as are many pipe-to-fitting situations. This configuration is obtained simply by loosening the tightening knobs 2306 on one set of side members 2302 and sliding the set of side members 2302 along the bars 2304 to the desired position.

The Chain Scanner

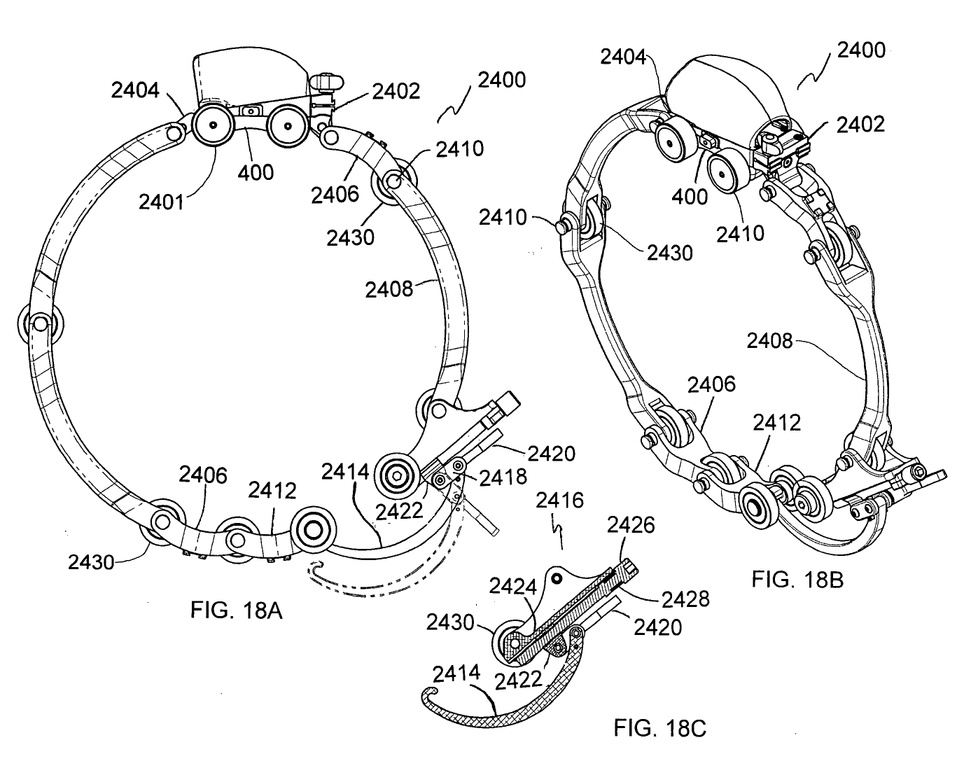

Referring to FIGS. 18A through 18C, the chain scanner, identified generally by reference numeral 2400, is a scanner equipped for circumferential scanning of a ferrous or non-ferrous pipe or small vessel. Referring to FIGS. 18A and 18B, it is based off of the wheel base assembly 400, which is modified to include non-magnetic wheels 2401, a special nose 2402, and a tail 2404. A combination of short links 2406 and long links 2408 are attached to the nose 2402 and tail 2404. The links 2406 and 2408 are fastened together with quick release catches 2410 to form a continuous chain. Short links 2406 and long links 2408 may be added or removed to provide a chain length appropriate for the pipe being inspected. It will be understood that only long links 2408 or only short links 2406 may also be used. Referring to FIG. 18A, a special catch link 2412 provides a connection point for the hook 2414 of the buckle assembly 2416 to attach to. Referring to FIG. 18C, the buckle assembly 2416 includes the hook 2414, a link 2418, a handle 2420 which is rigidly attached to the link 2418, and a movable lug 2422, all of which together provide a quick release over-center clamping mechanism for clamping the chain scanner 2400 onto a pipe. The movable lug 2422 slides in a dovetail groove in the buckle base 2424 and is held in a fixed location with a thumb screw 2426. The thumb screw 2426 is allowed to rotate freely within but retained axially by a mounting bracket 2428 which is anchored on the buckle base 2424. By turning the thumb screw 2426, the movable lug 2422 slides along the dovetail groove so that the effective length of the buckle assembly 2416 changes, thus changing the overall length of the chain scanner 2400. In this manner the chain tension is finely tuned to exactly suit the pipe diameter.

Referring to FIG. 18A, the short links 2406, long links 2408, and buckle base 2424 all include an elastomer coated bearing 2430 (the catch link 2412 has two) to allow for relatively effortless motion of the scanner around the pipe.

Referring to FIG. 18B, the nose 2402 provides a connection point for either a simple bar onto which may be attached a number of probe holders, or a lateral probe positioner assembly 2200.

The chain scanner 2400 may be used on very small pipe by removing all but one short link 2406 and all the long links 2408, leaving just the wheel base assembly 400, one short link 2406, and the buckle assembly 2416. When this is the case, the hook 2414 of the buckle assembly 2416 may be connected directly to an attachment point in the tail 2404.

Examples of scanner assemblies that may be constructed using the assemblies described above will now be given with reference to FIGS. 19A through 22.

Simplified Scanner Assembly

Referring to FIGS. 19A and 19D, a simplified scanner assembly is identified generally by reference numeral 700. Simplified scanner assembly 700 is a scanner constructed of a specific subset of the previously described, interlocking components for the purpose of scanning cylindrical surfaces in the longitudinal or circumferential direction. This configuration is relatively small and has the capability of holding from one to four probes and can accommodate cylindrical surfaces having a diameter of 3″ to infinity.

Referring to FIGS. 19A and 19B, when only one probe holder assembly 200 is required, the scanner 700 is constructed from the following components or sub-assemblies: wheel base assembly 400, probe holder assembly 200, umbilical assembly 500, arm assembly 600, and ergonomic handle 502.

The arm assembly 600 is commonly used when scanning cylindrical surfaces in the circumferential direction. It is designed to position the probe midway between the front and back wheels on the wheel base assembly 400. This is highly advantageous in that it allows for scanning any radius of cylinder without having to adjust the probe position. The arm assembly 600 need not be used when scanning cylindrical surfaces in the longitudinal direction, in which case the probe holding assembly 200 can be fitted directly on the front of the wheel base assembly 400.

When multiple probe holders 200 are required, a combination of dovetail bars 28 and connecting assemblies such as the connector block 36, the cross block 52, the pivot assembly 64, and the swivel assembly 80 as described above is used to mount the probe holder assemblies 200 in the appropriate positions.

Complex Scanner Assembly

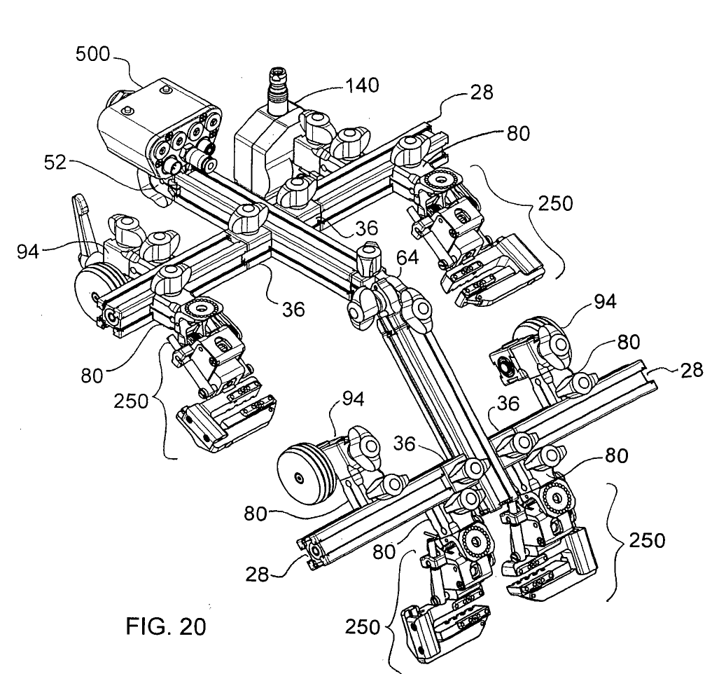

Referring to FIG. 20, an example of a more complex scanner assembly is shown, and identified generally by reference numeral 800. Scanner assembly 800 is constructed using many of the interlocking components previously described above to accomplish scanning tasks that are not suitable using a more simplified scanner 700.

The framework is constructed of dovetail bars 28 and connecting assemblies such as the connector block assembly 36, the cross block assembly 52, the pivot assembly 64, and swivel assembly 80. In some situations, a series of bars 28 of appropriate length joined end to end with pivot blocks 80 would form a ‘spine’ that conforms to the radius of a cylindrical surface. Additional bars 28 of suitable length can then be affixed to the ‘spine’ by means of connector blocks 36 to form side arms on which wheel block assemblies 94, encoded wheel block assemblies 140, and probe holder assemblies 250 can be fixed.

Preferably, a minimum of three wheel block assemblies 94, and one encoded wheel block assembly 140 would be affixed to the frame by means of swivel assembly 80 which allows the magnetic wheel assembly 102 to contact the surface in the optimum orientation thus maximizing the magnetic attraction force. The umbilical assembly 500 can be conveniently mounted to the end of a bar 28 by means of cross block assembly 52 or in the middle of any bar 28 using a connector block 36.

This configuration is but one of many hundreds of arrangements that could be constructed with the system of components described in this document.

A Sectional Frame Scanner Assembly

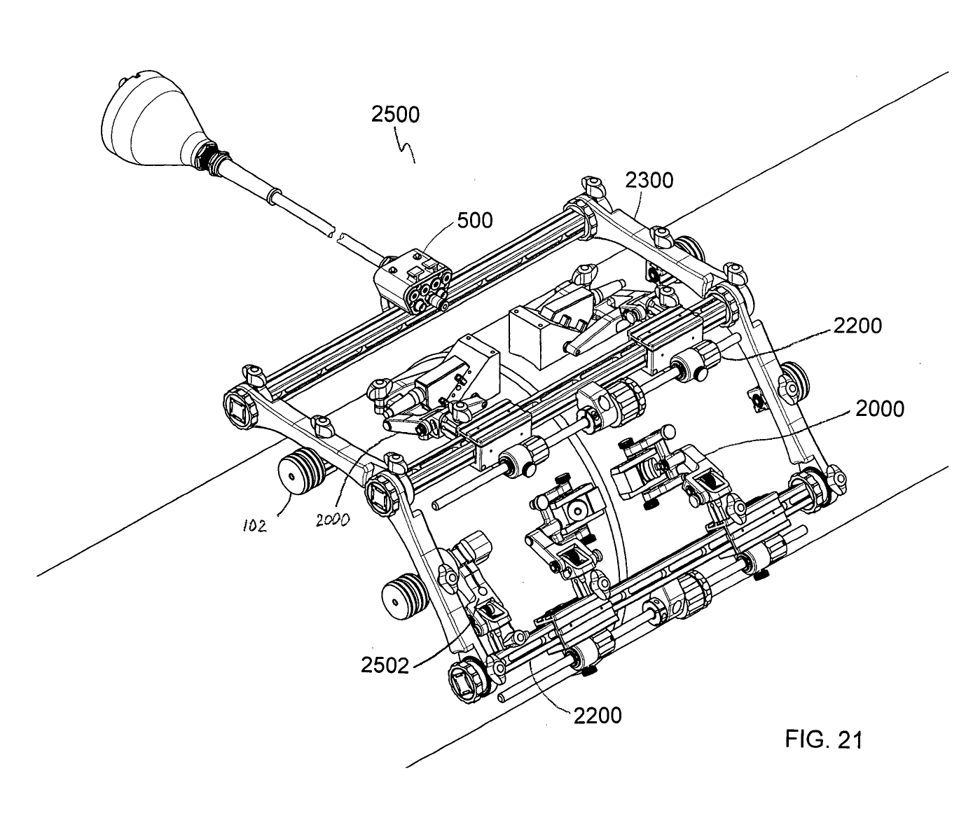

Referring to FIG. 21, a sectional frame scanner, identified generally by reference number 2500, is shown. This scanner assembly 2500 is based on the sectional frame assembly 2300 shown in for the purpose of scanning cylindrical surfaces in the circumferential direction. It is capable of holding multiple probe sets attached to either the bars of the sectional frame assembly 2300 or the slider assemblies 2202 of a lateral probe positioner assembly 2200. It can accommodate cylindrical surfaces having a diameter of 3″ to infinity.

FIG. 21 shows one of many possible configurations of the sectional frame scanner assembly 2500. In this particular embodiment, the sectional frame scanner 2500 includes the sectional frame assembly 2300 shown in FIGS. 17A through 17F with two lateral probe positioner assemblies 2200, four swing arm probe holder assemblies 2000, an umbilical 500 attached with a cross block assembly 54, and a spring loaded encoder 2502. This spring loaded encoder has a rubber wheel that rolls on the inspection surface and provides positional information to an inspection instrument. The magnetic attraction of the scanner is nearly doubled with the addition of four extra wheel assemblies 102 installed on the shaft of and in reversed polarity with respect to the wheels on the sectional frame assembly. The wheels on the sectional frame assembly 2300 are specifically positioned with respect to the probe holders 2000 to ensure proper probe contact with the inspected surface regardless of the size of the pipe or vessel being inspected.

A Chain Scanner Assembly

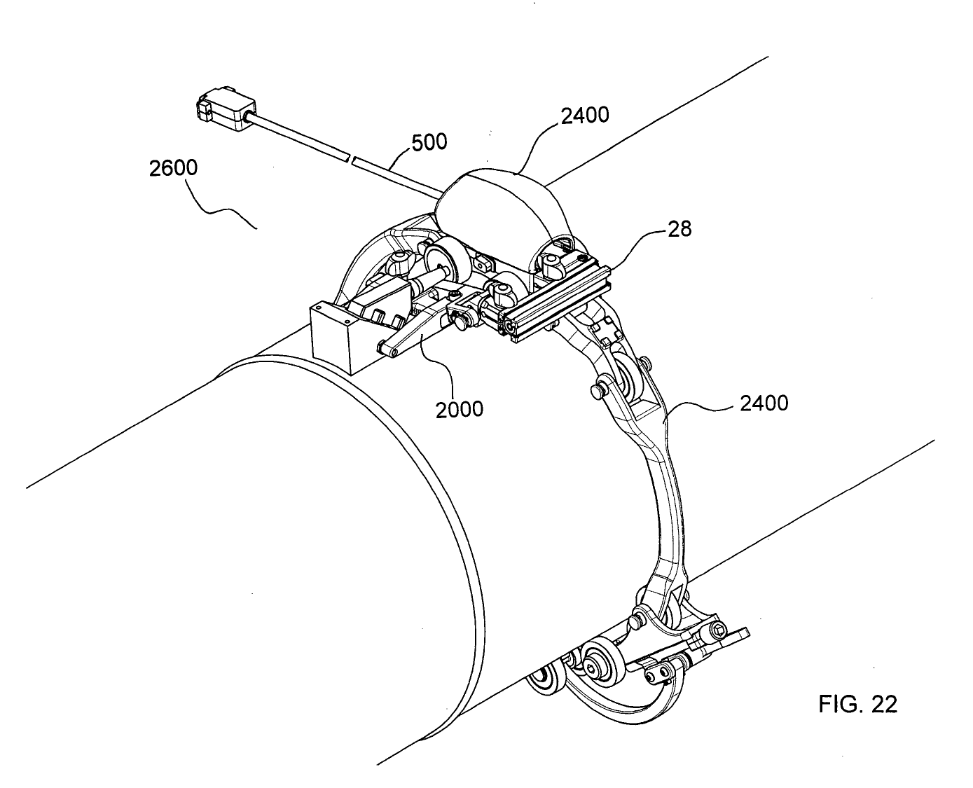

Referring to FIG. 22, a chain scanner assembly is shown and identified generally by reference number 2600. It is based on the chain scanner 2400 described above with reference to FIGS. 18A through 18C and is used to scan cylindrical surfaces in the circumferential direction. It is capable of holding multiple probe sets attached to either a bar assembly 28 or the slider assemblies 2202 of a lateral probe positioner assembly 2200, both of which are fastened to the nose 2402 of the chain scanner 2400. It can accommodate cylindrical surfaces having a diameter of 3″ to infinity.

Again, this is one of many possible configurations of the chain scanner assembly 2500. In this particular embodiment, the chain scanner assembly 2600 includes the chain scanner 2400, one bar assembly 28, one swing arm probe holder assemblies 2000, and an umbilical 500 docked on the chain scanner 2400.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A modular scanner assembly, comprising:
a probe holder support constructed from interconnected reconfigurable members;
at least one of the interconnected reconfigurable members having a probe holder;
the probe holder support having wheels attached to at least one interconnected reconfigurable member for moving the probe holder support across a surface to be scanned.

2. The modular scanner assembly of claim 1, wherein at least one of the wheels is connected to a position encoder.

3. The modular scanner assembly of claim 1, wherein the wheels are magnetic wheels for magnetically maintaining the position of the probe holder support on a metal object.

4. The modular scanner assembly of claim 1, wherein the probe holder has a first pivot axis, the first pivot axis being biased such that the probe is biased toward the surface to be scanned.

5. The modular scanner assembly of claim 4, wherein the probe holder has a second pivot axis.

6. The modular scanner assembly of claim 1, wherein the probe holder has a ball joint for allowing omni-directional orientation of the probe

7. The modular scanner assembly of claim 1, wherein the probe holder comprises a pivot assembly and a clamp assembly.

8. The modular scanner assembly of claim 1, wherein the interconnected reconfigurable members of the probe holder support are connected by universal connectors or by intermediate components having universal connectors.

9. The modular scanner assembly of claim 8, wherein some of the universal connectors have a projecting engagement tongue with an enlarged end and other of the universal connectors have an engagement channel for engaging the engagement tongue.

10. The modular scanner assembly of claim 8, wherein the universal connectors are two part connectors with one the interconnected reconfigurable members having a first part of the two-part connector, and components that attach to the one interconnected reconfigurable member having a second part of the two-part connector, the first part and the second part of the two-part connector being adapted to be connected.

11. The modular scanner assembly of claim 8, wherein at least one of the interconnected reconfigurable members defines an attachment channel and the universal connectors have a projecting engagement tongue with an enlarged end that engages the attachment channel when the universal connector is inserted into the attachment channel, means being provided to lock the universal connector in position.

12. The modular scanner assembly of claim 1, wherein at least some of the interconnected reconfigurable members of the probe holder support form a ring which is adapted to encircle a cylindrical work piece.

13. The modular scanner assembly of claim 1, wherein at least some of the interconnected reconfigurable members of the probe holder support form a frame, with parallel spaced side members and transverse cross members extending between the parallel spaced side members.

14. The modular scanner assembly of claim 13, wherein the parallel spaced side members of the frame have at least one articulating joint, thereby enabling articulation of the frame to conform to a curvature on a work piece.

15. The modular scanner assembly of claim 13, wherein means are provided to move the probe holders along the transverse cross members, thereby repositioning the probe holders on the frame.

16. The modular scanner assembly of claim 13, wherein at least one side member is adapted to slide along the cross member toward another side member.

17. The modular scanner assembly of claim 1, wherein the interconnected reconfigurable members of the probe holder support form a spine, with cantilever members extending outwardly from the spine.

18. The modular scanner assembly of claim 17, wherein the spine has at least one articulating joint, thereby enabling articulation of the spine to conform to a curvature on a work piece.

19. The modular scanner assembly of claim 1, wherein at least on of the interconnected reconfigurable members of the probe holder support is an arm that has a first end attachable to another of the interconnected reconfigurable members and a second end that is attachable to an interconnected reconfigurable members having a probe holder.

20. The modular scanner assembly of claim 1, wherein means are provided to adjust the angular positioning of the probe within the probe holder.

21. The modular scanner assembly of claim 1, further comprising at least one communicator for carrying signals from a probe held by the probe holder.

22. The modular scanner assembly of claim 21 wherein the communicator is an umbilical cable connector assembly connecting a cable to the probe holder for carrying signals from a probe held by the probe holder.
